(19) United States
(12) Patent Application Publication
(10) Pub. No.: US 2023/0246271 A1
(43) Pub. Date: Aug. 3, 2023

(54) SECONDARY BATTERY

(71) Applicant: MURATA MANUFACTURING CO., LTD., Kyoto (JP)

(72) Inventors: Taichi KATSUMOTO, Kyoto (JP); Yoshiichi HORIKOSHI, Kyoto (JP); Masayuki KAGEYAMA, Kyoto (JP)

(21) Appl. No.: 18/174,224

(22) Filed: Feb. 24, 2023

Related U.S. Application Data
(63) Continuation of application No. PCT/JP2021/027130, filed on Jul. 20, 2021.

(30) Foreign Application Priority Data
Aug. 26, 2020 (JP) 2020-142627

(51) Int. Cl. H01M 50/181; H01M 50/169; H01M 10/0587; H01M 10/0525; H01M 50/109

(52) U.S. Cl. CPC H01M 50/181; H01M 50/169; H01M 10/0587; H01M 10/0525; H01M 50/109; H01M 50/543

(57) ABSTRACT

A secondary battery includes an outer package member, an electrode terminal, a battery device, a first wiring line, and a second wiring line. The outer package member has a flat and columnar shape and includes a first bottom part and a second bottom part opposed to each other. The electrode terminal is provided on the first bottom part and is insulated from the first bottom part. The battery device is contained inside the outer package member and includes a first electrode and a second electrode. The first electrode and the second electrode are opposed to each other and are wound. The first wiring line is so coupled to the first electrode as to protrude from the battery device toward the first bottom part and is coupled to the electrode terminal. The second wiring line is so coupled to the second electrode as to protrude from the battery device toward the first bottom part and is coupled to the first bottom part. The battery device has a winding center space at a center around which the first electrode and the second electrode are each wound. The second wiring line includes a tip part that is bent in a direction approaching the winding center space and is coupled to the first bottom part.

### CROSS REFERENCE TO RELATED APPLICATIONS

The present application is a continuation of PCT patent application no. PCT/JP2021/027130, filed on Jul. 20, 2021, which claims priority to Japanese patent application no. JP2020-142627, filed on Aug. 26, 2020, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, in a button battery in which two metallic housing half-parts are crimped to each other, in order to improve resistance to mechanical loads, a positive electrode lead is coupled to one of the housing half-parts, and a negative electrode lead is coupled to another of the housing half-parts.

Further, in a coin-type battery including a coin-type battery can, in order to obtain a high discharge load characteristic, a positive electrode lead is so coupled to a positive electrode as to protrude from a wound body toward a cover, and a negative electrode lead is so coupled to a negative electrode as to protrude from the wound body toward the cover. In this case, the battery can and the cover are welded to each other in a state in which the positive electrode lead is sandwiched by the battery can and the cover.

### SUMMARY

The present technology relates to a secondary battery.

Consideration has been given in various ways to improve performance of a secondary battery; however, the secondary battery still remains insufficient in manufacturing stability. Accordingly, there is still room for improvement in terms thereof.

It is therefore desirable to provide a secondary battery that is able to achieve superior manufacturing stability.

A secondary battery according to an embodiment of the present technology includes an outer package member, an electrode terminal, a battery device, a first wiring line, and a second wiring line. The outer package member has a flat and columnar shape and includes a first bottom part and a second bottom part opposed to each other. The electrode terminal is provided on the first bottom part and is insulated from the first bottom part. The battery device is contained inside the outer package member and includes a first electrode and a second electrode. The first electrode and the second electrode are opposed to each other and are wound. The first wiring line is so coupled to the first electrode as to protrude from the battery device toward the first bottom part and is coupled to the electrode terminal. The second wiring line is so coupled to the second electrode as to protrude from the battery device toward the first bottom part and is coupled to the first bottom part. The battery device has a winding center space at a center around which the first electrode and the second electrode are each wound. The second wiring line includes a tip part that is bent in a direction approaching the winding center space and is coupled to the first bottom part.

According to the secondary battery of an embodiment of the present technology, the first wiring line is so coupled to the first electrode as to protrude from the battery device toward the first bottom part and is coupled to the electrode terminal, the second wiring line is so coupled to the second electrode as to protrude from the battery device toward the first bottom part and is coupled to the first bottom part, and the tip part of the second wiring line is bent in the direction approaching the winding center space and is coupled to the first bottom part. This makes it possible to achieve superior manufacturing stability.

Note that effects of the present technology are not necessarily limited to those described above and may include any of a series of effects described herein in relation to the present technology.

### BRIEF DESCRIPTION OF THE FIGURES

FIG. 1 is a perspective view of a configuration of a secondary battery according to an embodiment of the present technology.

FIG. 2 is a sectional view of the configuration of the secondary battery illustrated in FIG. 1.

FIG. 3 is a plan view of respective configurations of a battery device, a positive electrode lead, and a negative electrode lead illustrated in FIG. 2.

FIG. 4 is a sectional view of the configuration of the battery device illustrated in FIG. 2.

FIG. 5 is a perspective view of a configuration of an outer package can to be used in a process of manufacturing the secondary battery.

FIG. 6 is a sectional diagram illustrating the configuration of the outer package can for describing the process of manufacturing the secondary battery.

FIG. 7 is a sectional view of a configuration of a secondary battery of a first comparative example.

FIG. 8 is a sectional view of a configuration of a secondary battery of a second comparative example.

FIG. 9 is a sectional view of a configuration of a secondary battery according to an embodiment.

FIG. 10 is a sectional view of a configuration of a secondary battery according to an embodiment.

FIG. 11 is a sectional view of a configuration of a secondary battery according to an embodiment.

FIG. 12 is a sectional view of a configuration of a secondary battery according to an embodiment.

FIG. 13 is a plan view of a configuration of a secondary battery according to an embodiment.

FIG. 14 is a plan view of a configuration of a secondary battery according to an embodiment.

FIG. 15 is a plan view of a configuration of a secondary battery according to an embodiment.

FIG. 16 is a sectional view of a configuration of a secondary battery according to an embodiment.

### DETAILED DESCRIPTION

One or embodiments of the present technology are described below in further detail including with reference to the drawings.

A description is given of a secondary battery according to an embodiment of the present technology.

The secondary battery to be described here is a secondary battery that has a flat and columnar three-dimensional shape, and is commonly referred to by a term such as a coin type or a button type. As will be described later, the secondary battery includes two bottom parts opposed to each other, and a sidewall part lying between the two bottom parts. This secondary battery has a height smaller than an outer diameter. The “outer diameter” is a diameter (a maximum diameter) of each of the two bottom parts. The “height” is a distance (a maximum distance) from one of the bottom parts to another of the bottom parts.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to suppress precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains the battery capacity using insertion and extraction of lithium is a so-called lithium-ion secondary battery. In the lithium-ion secondary battery, lithium is inserted and extracted in an ionic state.

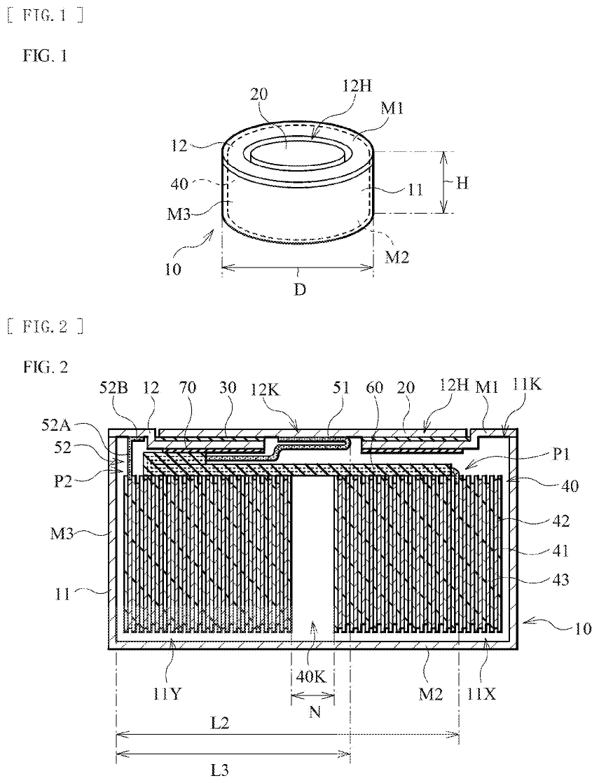

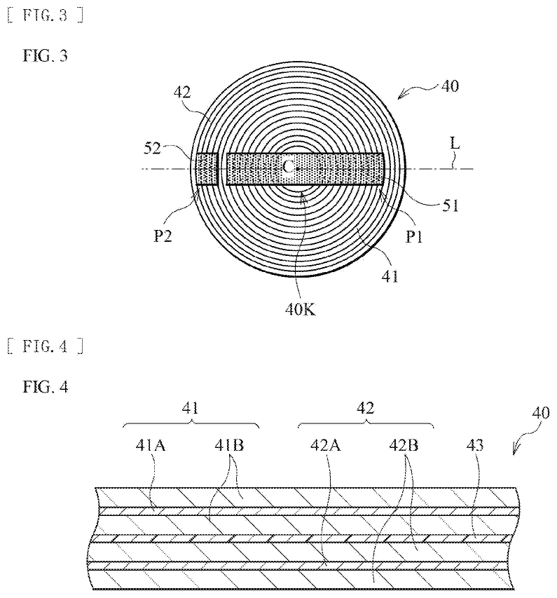

FIG. 1 illustrates a perspective configuration of the secondary battery. FIG. 2 illustrates a sectional configuration of the secondary battery illustrated in FIG. 1. FIG. 3 illustrates respective planar configurations of a battery device 40, a positive electrode lead 51, and a negative electrode lead 52 illustrated in FIG. 2. FIG. 4 illustrates a sectional configuration of the battery device 40 illustrated in FIG. 2. Note that FIG. 4 illustrates only a portion of the sectional configuration of the battery device 40 in an enlarged manner.

For convenience, the following description is given with an upper side of each of FIGS. 1 and 2 assumed as an upper side of the secondary battery, and a lower side of each of FIGS. 1 and 2 assumed as a lower side of the secondary battery.

As illustrated in FIG. 1, the secondary battery has an outer diameter D and a height H, and has such a three-dimensional shape that the height H is smaller than the outer diameter D, that is, the flat and columnar three-dimensional shape as described above. Here, the three-dimensional shape of the secondary battery is flat and cylindrical (circular columnar).

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., a dimensional ratio D/H, is greater than 1. Although not particularly limited, an upper limit of the dimensional ratio D/H is preferably less than or equal to 25.

Specifically, as illustrated in FIGS. 1 to 4, the secondary battery includes an outer package can 10, an external terminal 20, the battery device 40, the positive electrode lead 51, and the negative electrode lead 52. Here, the secondary battery further includes a gasket 30, a sealant 60, and an insulating film 70.

As illustrated in FIGS. 1 and 2, the outer package can 10 is an outer package member having a flat and columnar shape, and has a hollow structure to contain the battery device 40 and other components therein.

Here, the outer package can 10 has a flat and cylindrical three-dimensional shape corresponding to the three-dimensional shape of the secondary battery which is flat and cylindrical. Accordingly, the outer package can 10 includes an upper bottom part M1 and a lower bottom part M2 opposed to each other, and more specifically, includes a sidewall part M3 lying between the upper bottom part M1 and the lower bottom part M2, together with an upper end part M1 and a lower end part M2.

The upper bottom part M1 serves as a first bottom part, and the lower bottom part M2 serves as a second bottom part. An upper end part of the sidewall part M3 is coupled to the upper bottom part M1. A lower end part of the sidewall part M3 is coupled to the lower bottom part M2. As described above, the outer package can 10 is cylindrical. Thus, the upper bottom part M1 and the lower bottom part M2 are each circular in planar shape, and a surface of the sidewall part M3 is a convexly curved surface.

The outer package can 10 includes a container part 11 and a cover part 12. The container part 11 is sealed by the cover part 12. Here, the cover part 12 is welded to the container part 11.

The container part 11 is a container member having a flat and cylindrical shape and containing the battery device 40 and other components inside. The container part 11 corresponds to the lower bottom part M2 and the sidewall part M3 that have an opening 11K. The container part 11 has a hollow structure with an upper end part open and a lower end part closed, and the upper end part of the container part 11 is thus provided with the opening 11K as described above.

The cover part 12 is a substantially disk-shaped cover member that shields the opening 11K provided in the container part 11. The cover part 12 corresponds to the upper bottom part M1. The cover part 12 has a through hole 12K, and is welded to the container part 11 at the opening 11K. The external terminal 20 is provided on the cover part 12, and the cover part 12 thus supports the external terminal 20.

Here, the cover part 12 is so bent as to protrude in part toward the inside of the outer package can 10 (the container part 11). The cover part 12 is thus recessed in part. In other words, a portion of the cover part 12 is so bent as to form a step toward a center of the cover part 12. The cover part 12 thus includes a recessed part 12H. The recessed part 12H is provided by the cover part 12 being so bent as to protrude in part toward the inside of the container part 11. The cover part 12 is bent once to have the recessed part 12H. The cover part 12 including the recessed part 12H thus has one step. Note that the through hole 12K is provided in the recessed part 12H.

As described above, the outer package can 10 is a can (a so-called welded can) in which two members (the container part 11 and the cover part 12) are welded to each other. As a result, the outer package can 10 after undergoing welding is physically a single member as a whole, and is thus in a state of being not separable into the two members (the container part 11 and the cover part 12) afterward.

The outer package can 10 as a welded can does not include any portion folded over another portion, and does not include any portion in which two or more members lie over each other.

The wording “does not include any portion folded over another portion” means that the outer package can 10 is not so processed as to include a portion folded over another portion. The wording “does not include any portion in which two or more members lie over each other” means that the outer package can 10 after completion of the secondary battery is physically a single member and is thus not separable into two or more members afterward. That is, the outer package can 10 is not in a state in which two or more members are assembled to each other in such a manner as to be separable afterward.

In particular, the outer package can 10 as a welded can is a can (a so-called crimpless can) different from a crimped can which is formed by means of crimping processing. A reason for employing the crimpless can is that this increases a device space volume inside the outer package can 10, and accordingly increases an energy density per unit volume. The “device space volume” refers to a volume (an effective volume) of an internal space of the outer package can 10 available for containing therein the battery device 40 which is to be involved in charging and discharging reactions.

Here, the outer package can 10 including the container part 11 and the cover part 12 is electrically conductive. The outer package can 10 is coupled to the battery device 40 (the negative electrode 42) via the negative electrode lead 52. The outer package can 10 thus serves as an external coupling terminal for the negative electrode 42. A reason for employing such a configuration is that this makes it unnecessary for the secondary battery to be provided with an external coupling terminal for the negative electrode 42 separate from the outer package can 10, and thus suppresses a decrease in device space volume resulting from providing the external coupling terminal for the negative electrode 42. As a result, the device space volume increases, and accordingly, the energy density per unit volume increases.

For example, the outer package can 10 (the container part 11 and the cover part 12) includes one or more of electrically conductive materials including, without limitation, a metal material and an alloy material. Examples of the electrically conductive materials include iron, copper, nickel, stainless steel, an iron alloy, a copper alloy, and a nickel alloy. Although the stainless steel is not particularly limited in kind, specific examples of the stainless steel include SUS304 and SUS316. Note that the container part 11 and the cover part 12 may include the same material, or may include respective different materials.

As will be described later, the outer package can 10 (the cover part 12) is insulated, via the gasket 30, from the external terminal 20 which serves as an external coupling terminal for the positive electrode 41. A reason for this is that contact between the outer package can 10 (the external coupling terminal for the negative electrode 42) and the external terminal 20 (the external coupling terminal for the positive electrode 41) is suppressed.

As illustrated in FIGS. 1 and 2, the external terminal 20 is an electrode terminal to be coupled to electronic equipment when the secondary battery is mounted on the electronic equipment. As described above, the external terminal 20 is provided on the outer package can 10, and is more specifically provided on the cover part 12. Accordingly, the external terminal 20 is insulated from the cover part 12 via the gasket 30 and supported by the cover part 12.

Here, the external terminal 20 is coupled to the battery device 40 (the positive electrode 41) via the positive electrode lead 51. The external terminal 20 thus serves as the external coupling terminal for the positive electrode 41. Accordingly, upon use of the secondary battery, the secondary battery is coupled to electronic equipment via the external terminal 20 (the external coupling terminal for the positive electrode 41) and the outer package can 10 (the external coupling terminal for the negative electrode 42). This allows the electronic equipment to operate with use of the secondary battery as a power source.

The external terminal 20 is a flat and substantially plate-shaped member, and is disposed inside the recessed part 12H with the gasket 30 interposed therebetween. The external terminal 20 is thus insulated from the cover part 12 via the gasket 30 as described above. Here, the external terminal 20 is entirely disposed inside the recessed part 12H, and the external terminal 20 thus does not protrude above the cover part 12 (the recessed part 12H). A reason for this is that this reduces the height H of the secondary battery and therefore increases the energy density per unit volume as compared with a case where the external terminal 20 protrudes above the cover part 12.

Note that the external terminal 20 has an outer diameter smaller than an inner diameter of the recessed part 12H. Thus, the external terminal 20 is separated from the cover part 12 surrounding the external terminal 20. Accordingly, the gasket 30 is disposed only in a portion of a region between the external terminal 20 and the cover part 12 inside the recessed part 12H. More specifically, the gasket 30 is disposed only at a location where the external terminal 20 and the cover part 12 would be in contact with each other if it were not for the gasket 30.

The external terminal 20 includes one or more of electrically conductive materials including, without limitation, a metal material and an alloy material. Examples of the electrically conductive materials include aluminum and an aluminum alloy. Note that the external terminal 20 may include a cladding material. The cladding material includes an aluminum layer and a nickel layer that are disposed in order from a side closer to the gasket 30. In the cladding material, the aluminum layer and the nickel layer are roll-bonded to each other.

The gasket 30 is an insulating member interposed between the outer package can 10 (the cover part 12) and the external terminal 20, as illustrated in FIG. 2. The external terminal 20 is fixed to the cover part 12 via the gasket 30. Here, the gasket 30 is ring-shaped in a plan view, and has a through hole at a location corresponding to the through hole 12K. The gasket 30 includes one or more of insulating materials including, without limitation, a polymer compound having an insulating property. Examples of the insulating materials include polypropylene and polyethylene.

A range of placement of the gasket 30 is not particularly limited, and may be chosen as desired. Here, the gasket 30 is disposed between a top surface of the cover part 12 and a bottom surface of the external terminal 20 inside the recessed part 12H, as described above.

The battery device 40 is a power generation device that causes charging and discharging reactions to proceed. As illustrated in FIGS. 2 to 4, the battery device 40 is contained inside the outer package can 10. The battery device 40 includes the positive electrode 41 and the negative electrode 42. Here, the battery device 40 further includes a separator 43, and an electrolytic solution which is a liquid electrolyte. The electrolytic solution is not illustrated.

For example, the battery device 40 is a so-called wound electrode body. That is, in the battery device 40, the positive electrode 41 and the negative electrode 42 are stacked on each other with the separator 43 interposed therebetween, and the stack of the positive electrode 41, the negative electrode 42, and the separator 43 is wound. The positive electrode 41 and the negative electrode 42 are opposed to each other, and are wound. As a result, the battery device 40 has a winding center space 40K having a cylindrical shape at a center around which the positive electrode 41 and the negative electrode 42 are each wound. The winding center space 40K does not contribute to charging and discharging reactions because neither the positive electrode 41 nor the negative electrode 42 is present therein. The winding center space 40K has an inner diameter N.

Here, the positive electrode 41, the negative electrode 42, and the separator 43 are wound in such a manner that the separator 43 is disposed in each of an outermost wind and an innermost wind and the negative electrode 42 is disposed on an outer side of winding relative to the positive electrode 41. Alternatively, the positive electrode 41 may be disposed on the outer side of the winding relative to the negative electrode 42. Respective numbers of winds of the positive electrode 41, the negative electrode 42, and the separator 43 are not particularly limited, and may be chosen as desired.

The battery device 40 has a three-dimensional shape similar to that of the outer package can 10, that is, a flat and cylindrical three-dimensional shape. A reason for this is that this helps to prevent a so-called dead space (a surplus space between the outer package can 10 and the battery device 40) from resulting when the battery device 40 is placed inside the outer package can 10, and to thereby allow for efficient use of the internal space of the outer package can 10, as compared with a case where the battery device 40 has a three-dimensional shape different from that of the outer package can 10. As a result, the device space volume increases, and accordingly, the energy density per unit volume increases.

Although not specifically illustrated here, a side surface (a peripheral surface) of the battery device 40 which is the wound electrode body may be covered by a protective tape including an insulating material such as polyimide. The protective tape serves to protect a surface of the battery device 40, and to fix the positive electrode 41, the negative electrode 42, and the separator 43 each wound.

The positive electrode 41 is a first electrode to be used to cause the charging and discharging reactions to proceed. As illustrated in FIG. 4, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

Here, the positive electrode active material layer 41B is provided on each of the two opposed surfaces of the positive electrode current collector 41A. The positive electrode active material layer 41B includes one or more of positive electrode active materials into which lithium is insertable and from which lithium is extractable. Note that the positive electrode active material layer 41B may be provided only on one of the two opposed surfaces of the positive electrode current collector 41A on a side where the positive electrode 41 is opposed to the negative electrode 42. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. A reason for this is that a high energy density is obtainable. Note that the lithium compound may further include one or more of other elements (elements other than lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 is a second electrode to be used to cause the charging and discharging reactions to proceed. As illustrated in FIG. 4, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

Here, the negative electrode active material layer 42B is provided on each of the two opposed surfaces of the negative electrode current collector 42A. The negative electrode active material layer 42B includes one or more of negative electrode active materials into which lithium is insertable and from which lithium is extractable. Note that the negative electrode active material layer 42B may be provided only on one of the two opposed surfaces of the negative electrode current collector 42A on a side where the negative electrode 42 is opposed to the positive electrode 41. The negative electrode active material layer 42B may further include other materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 42B is not particularly limited, and specifically includes one or more of methods including, without limitation, a coating method, a vapor-phase method, a liquid-phase method, a thermal spraying method, and a firing (sintering) method.

The negative electrode active material includes a carbon material, a metal-based material, or both. A reason for this is that a high energy density is obtainable. Examples of the carbon material include graphitizable carbon, non-graphitizable carbon, and graphite (natural graphite and artificial graphite). The metal-based material is a material that includes, as a constituent element or constituent elements, one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. That is, the negative electrode 42 protrudes upward relative to the positive electrode 41, and protrudes downward relative to the positive electrode 41. A reason for this is that this suppresses precipitation of lithium extracted from the positive electrode 41. The “height” is a dimension corresponding to the height H of the secondary battery described above, that is, a dimension in a vertical direction in each of FIGS. 1 and 2. The definition of the height described here applies also to the following.

The separator 43 is an insulating porous film interposed between the positive electrode 41 and the negative electrode 42 as illustrated in FIGS. 2 and 4. The separator 43 allows lithium ions to pass therethrough while preventing a short circuit between the positive electrode 41 and the negative electrode 42. The separator 43 includes a polymer compound such as polyethylene.

Here, the separator 43 has a height greater than the height of the negative electrode 42. That is, the separator 43 protrudes upward relative to the negative electrode 42, and protrudes downward relative to the negative electrode 42. A reason for this is that the separator 43 is used to insulate the positive electrode lead 51 from the battery device 40 (the negative electrode 42).

The electrolytic solution includes a solvent and an electrolyte salt. The positive electrode 41, the negative electrode 42, and the separator 43 are each impregnated with the electrolytic solution. The solvent includes one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents is a so-called non-aqueous electrolytic solution. The electrolyte salt includes one or more of light metal salts including, without limitation, a lithium salt.

As illustrated in FIGS. 2 and 3, the positive electrode lead 51 is a first wiring line that is contained inside the outer package can 10 and is coupled to each of the positive electrode 41 and the external terminal 20. Here, the secondary battery includes one positive electrode lead 51. In each of FIGS. 2 and 3, the positive electrode lead 51 is shaded.

On a side where the battery device 40 is opposed to the cover part 12, i.e., the upper side, the positive electrode lead 51 is coupled to an upper end part of the positive electrode 41, and is more specifically coupled to an upper end part of the positive electrode current collector 41A. The positive electrode lead 51 is thereby so coupled to the positive electrode 41 as to protrude from the battery device 40 toward the cover part 12. That is, the positive electrode lead 51 protrudes upward from the battery device 40. Further, the positive electrode lead 51 is coupled to the bottom surface of the external terminal 20 via the through hole 12K provided in the cover part 12.

Although not particularly limited, a method of coupling the positive electrode lead 51 is specifically a welding method. Although not particularly limited in kind, the welding method specifically includes one or more of methods including, without limitation, a resistance welding method and a laser welding method. The details of the welding methods described here apply also to the following.

Here, the positive electrode lead 51 is insulated from the outer package can 10 (the cover part 12) and from the battery device 40 (the negative electrode 42), with use of each of the separator 43, the sealant 60, and the insulating film 70.

Specifically, as described above, the height of the separator 43 is greater than the height of the negative electrode 42. Accordingly, the positive electrode lead 51 is separated from the negative electrode 42 with the separator 43 interposed therebetween, and is thus insulated from the negative electrode 42 via the separator 43. A reason for this is that this suppresses contact between the positive electrode lead 51 and the negative electrode 42.

Further, the positive electrode lead 51 is covered at a periphery thereof by the sealant 60 having an insulating property. The positive electrode lead 51 is thereby insulated from each of the cover part 12 and the negative electrode 42 via the sealant 60. A reason for this is that this suppresses contact between the positive electrode lead 51 and the cover part 12, and also suppresses contact between the positive electrode lead 51 and the negative electrode 42.

In this case, the sealant 60 is disposed between the positive electrode lead 51 and the negative electrode lead 52. The positive electrode lead 51 is thereby insulated from the negative electrode lead 52 via the sealant 60. A reason for this is that this suppresses contact between the positive electrode lead 51 and the negative electrode lead 52.

Furthermore, the insulating film 70 is disposed between the cover part 12 and the positive electrode lead 51. The positive electrode lead 51 is thereby insulated from the cover part 12 via the insulating film 70. A reason for this is that this suppresses contact between the positive electrode lead 51 and the cover part 12.

Details of a material included in the positive electrode lead 51 are similar to the details of the material included in the positive electrode current collector 41A. Note that the material included in the positive electrode lead 51 and the material included in the positive electrode current collector 41A may be the same as or different from each other.

Here, the positive electrode lead 51 is coupled to the positive electrode 41 in a region X on a front side relative to the winding center space 40K (a right side in FIG. 2). Accordingly, a coupling position P1 of the positive electrode lead 51 to the positive electrode 41 is located in the region X. As is apparent from FIGS. 1 and 2, in a case where the battery device 40 is divided into two regions with respect to the winding center space 40K in a direction along the outer diameter D, the region X is one of the two regions that includes a location where the positive electrode lead 51 is coupled to the positive electrode 41.

In contrast, a region Y on a back side relative to the winding center space 40K (a left side in FIG. 2), which will be described later, is the other of the two regions that includes no location where the positive electrode lead 51 is coupled to the positive electrode 41, in the case where the battery device 40 is divided into the two regions with respect to the winding center space 40K in the direction along the outer diameter D.

The positive electrode lead 51 may be coupled to the positive electrode 41 in the outermost wind, in the innermost wind, or in the middle of the winding between the outermost wind and the innermost wind. FIG. 2 illustrates a case where the positive electrode lead 51 is coupled to the positive electrode 41 in the middle of the winding.

Here, the positive electrode lead 51 is bent between the battery device 40 and the external terminal 20, thus being folded back once or more. The number of times the positive electrode lead 51 is to be folded back is not particularly limited as long as it is once or more, and may be chosen as desired. What is meant by a wording “the positive electrode lead 51 is folded back” is that the positive electrode lead 51 is bent at an angle greater than 90° in the middle thereof.

Specifically, the positive electrode lead 51 is folded back once between the battery device 40 and the external terminal 20. A reason for this is that a folded-back portion of the positive electrode lead 51 serves as a surplus portion to provide a length margin of the positive electrode lead 51.

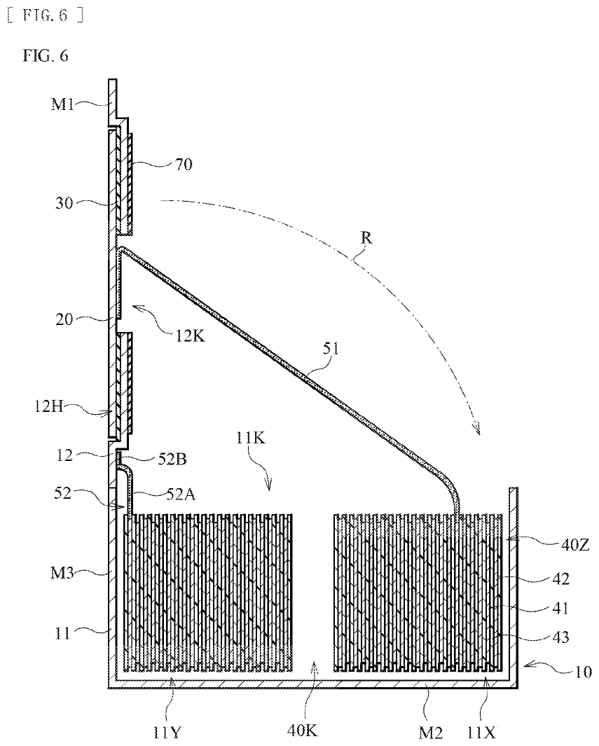

As a result, in forming the outer package can 10 using the container part 11 and the cover part 12 in a process of manufacturing the secondary battery, as will be described later, it is possible to set the cover part 12 upright relative to the container part 11. This makes it possible to weld the positive electrode lead 51 to the cover part 12 in a state in which the cover part 12 is set upright relative to the container part 11 (see FIG. 6).

In this case, a length of the positive electrode lead 51 is not particularly limited, and may be chosen as desired. Note that the length of the positive electrode lead 51 is preferably sufficiently large, in order to make it possible to weld the positive electrode lead 51 to the cover part 12 in a state in which the cover part 12 is set upright relative to the container part 11.

In particular, the length of the positive electrode lead 51 between the battery device 40 and the external terminal 20 preferably satisfies a relationship represented by Expression (1) below. A reason for this is that the length of the positive electrode lead 51 is secured, which makes it possible to weld the positive electrode lead 51 to the cover part 12 in a state in which the cover part 12 is set upright relative to the container part 11. A length L1 of the positive electrode lead 51 to be described here is a length of a portion of the positive electrode lead 51 that is located between the battery device 40 and the external terminal 20. Accordingly, the length L1 does not include a length of a portion of the positive electrode lead 51 that is coupled to the positive electrode 41 and a length of a portion of the positive electrode lead 51 that is coupled to the external terminal 20.

L1≥(L2+L3) (1)

where:
L1 is the length of the positive electrode lead 51 between the battery device 40 and the external terminal 20;
L2 is a distance from a position where the positive electrode lead 51 is coupled to the positive electrode 41, i.e., the coupling position P1, to the container part 11 (the sidewall part M3) located on a side opposite to the coupling position P1 across the winding center space 40K; and
L3 is a distance from the container part 11 (the sidewall part M3) located on the side opposite to the coupling position P1 across the winding center space 40K, to a position where the positive electrode lead 51 is coupled to the external terminal 20.

In this case, the positive electrode lead 51 is preferably extended from the region X to the region Y. A reason for this is that this increases the length margin of the positive electrode lead 51, as compared with a case where the positive electrode lead 51 is disposed only in the region X.

Note that, in a case where the positive electrode lead 51 is extended from the region X to the region Y, the positive electrode lead 51 is folded back once or more in the region Y. A reason for this is that the positive electrode lead 51 is finally guided to the external terminal 20, which makes it possible to couple the positive electrode lead 51 to the external terminal 20.

A contact area of the positive electrode lead 51 with the external terminal 20 is not particularly limited, and may be chosen as desired. In particular, the contact area of the positive electrode lead 51 with the external terminal 20 is preferably sufficiently large, in order to sufficiently fix the positive electrode lead 51 to the external terminal 20. Note that it is preferable that the contact area of the positive electrode lead 51 with the external terminal 20 be not excessively large, in order to provide a sufficiently large length of a portion of the positive electrode lead 51 that is not coupled to the external terminal 20, i.e., a sufficiently large length margin.

Note that the positive electrode lead 51 is physically separate from the positive electrode current collector 41A and is thus provided separately from the positive electrode current collector 41A. Alternatively, the positive electrode lead 51 may be physically continuous with the positive electrode current collector 41A and may thus be provided integrally with the positive electrode current collector 41A.

As illustrated in FIGS. 2 and 3, the negative electrode lead 52 is a second wiring line that is contained inside the outer package can 10 and is coupled to each of the negative electrode 42 and the outer package can 10 (the cover part 12). Here, the secondary battery includes one negative electrode lead 52. In each of FIGS. 2 and 3, the negative electrode lead 52 is shaded.

On the side where the battery device 40 is opposed to the cover part 12, i.e., the upper side, the negative electrode lead 52 is coupled to an upper end part of the negative electrode 42, and is more specifically coupled to an upper end part of the negative electrode current collector 42A. The negative electrode lead 52 is thereby so coupled to the negative electrode 42 as to protrude from the battery device 40 toward the cover part 12. That is, the negative electrode lead 52 protrudes upward from the battery device 40. Further, the negative electrode lead 52 is coupled to a bottom surface of the cover part 12. Details of methods usable for the coupling of the negative electrode lead 52 are similar to the details of the methods usable for the coupling of the positive electrode lead 51.

In particular, the negative electrode lead 52 includes a tip part 52B, and more specifically, includes the tip part 52B together with an intermediate part 52A. The intermediate part 52A is a portion that protrudes from the battery device 40 and is not coupled to the cover part 12. The tip part 52B is a portion that is coupled to the intermediate part 52A and is coupled to the cover part 12. The tip part 52B is bent in a direction approaching the winding center space 40K, instead of a direction away from the winding center space 40K. The tip part 52B thereby extends along the bottom surface of the cover part 12 and is coupled to the bottom surface of the cover part 12.

That is, the negative electrode lead 52 protrudes from the battery device 40 toward the cover part 12, and is bent in the middle thereof in such a manner that the tip part 52B faces the direction approaching the winding center space 40K, i.e., a direction approaching the external terminal 20. What is meant (defined) by a wording “the negative electrode lead 52 is bent” is not only a case where the negative electrode lead 52 is bent, but also a case where the negative electrode lead 52 is curved. The definition applies also to the following.

The negative electrode lead 52 includes the tip part 52B, and the tip part 52B is bent in the direction approaching the winding center space 40K and is coupled to the cover part 12 for the following reasons. This makes it easier for the negative electrode lead 52 to be welded to the cover part 12 and also makes it easier for the cover part 12 to be welded to the container part 11, in the process of manufacturing the secondary battery (a process of forming the outer package can 10 using the container part 11 and the cover part 12). Details of the reasons described here will be described later.

The intermediate part 52A is not particularly limited in configuration, as long as the tip part 52B is bent in the direction approaching the winding center space 40K. Here, the intermediate part 52A protrudes from the battery device 40 toward the cover part 12, and extends straight without being bent in the middle thereof. The negative electrode lead 52 is thus bent once as a whole. Accordingly, the negative electrode lead 52 (the intermediate part 52A) is not in contact with the container part 11 (the sidewall part M3), being separated from the sidewall part M3. A reason for employing such a configuration is that this keeps the negative electrode lead 52 away from the sidewall part M3, which helps to prevent occurrence of an issue due to creeping up of the electrolytic solution along the negative electrode lead 52, which will be described later.

Here, the separator 43 is disposed in the outermost wind in the battery device 40 as described above. The negative electrode lead 52 is thus not adjacent to the container part 11 (the sidewall part M3), being separated from the container part 11 (the sidewall part M3) with the separator 43 in the outermost wind interposed therebetween. A reason for this is that the separator 43 in the outermost wind serves as a protective member (a shock-resistant member) that physically protects the battery device 40, which prevents the battery device 40 from being damaged easily even if the secondary battery undergoes shock upon being dropped, for example. Another reason for this is that the separator 43 in the outermost wind is reached by and impregnated with the electrolytic solution, which increases an amount of the electrolytic solution held by the entire battery device 40.

Further, the negative electrode 42 is disposed on the outer side of the winding relative to the positive electrode 41, as described above. The negative electrode 42 in the outermost wind is thus separated from the container part 11 (the sidewall part M3) with the separator 43 in the outermost wind interposed therebetween. In this case, a distance (a separation distance) between the negative electrode 42 in the outermost wind and the container part 11 (the sidewall part M3) is preferably greater than or equal to a thickness of the separator 43. A reason for this is that this allows the separator 43 to be disposed between the negative electrode 42 in the outermost wind and the container part 11, and as a result, the negative electrode 42 in the outermost wind is separated from the container part 11 with the separator 43 in the outermost wind interposed therebetween, and the above-described roles of the separator 43 in the outermost wind (shock resistance and an ability to be impregnated with the electrolytic solution) are secured.

In particular, it is further preferable that the separation distance be greater than or equal to twice the thickness of the separator 43. A reason for this is that the negative electrode 42 in the outermost wind is further separated from the container part 11, which further prevents the battery device 40 from being damaged easily. Another reason for this is that this allows the protective tape described above to be disposed between the separator 43 in the outermost wind and the container part 11 on an as-needed basis, with the negative electrode 42 in the outermost wind separated from the container part 11 with the separator 43 in the outermost wind interposed therebetween.

In a case where the protective tape is disposed between the separator 43 in the outermost wind and the container part 11, the protective tape serves as a shock-resistant member as with the separator 43, which further prevents the battery device 40 from being damaged easily.

Here, to increase the length margin of the positive electrode lead 51, the positive electrode lead 51 is extended from the region X to the region Y as described above. In contrast, the tip part 52B is bent in the direction approaching the winding center space 40K as described above. The positive electrode lead 51 and the negative electrode lead 52 (the tip part 52B) are thus close to each other.

In this case, the tip part 52B is preferably so disposed as not to overlap with the positive electrode lead 51, in a state of being separated from the positive electrode lead 51. That is, in a case where the positive electrode lead 51 and the negative electrode lead 52 (the tip part 52B) are each viewed from above, it is preferable that the tip part 52B be terminated at a position before the positive electrode lead 51, without extending toward the direction approaching the winding center space 40K in such a manner as to overlap with the positive electrode lead 51. A reason for this is that this suppresses contact between the positive electrode lead 51 and the negative electrode lead 52 (the tip part 52B).

Details of a material included in the negative electrode lead 52 are similar to the details of the material included in the negative electrode current collector 42A. Note that the material included in the negative electrode lead 52 and the material included in the negative electrode current collector 42A may be the same as or different from each other.

Here, the negative electrode lead 52 is coupled to the negative electrode 42 in the region Y. Accordingly, a coupling position P2 of the negative electrode lead 52 to the negative electrode 42 is located in the region Y.

In this case, a positional relationship between the coupling position P1 of the positive electrode lead 51 and the coupling position P2 of the negative electrode lead 52 is not particularly limited, and may be chosen as desired.

In particular, the coupling positions P1 and P2 are preferably opposed to each other with the winding center space 40K interposed therebetween. That is, in a case where a straight line L passing through a center C of the battery device 40 (the winding center space 40K) is defined, it is preferable that the coupling positions P1 and P2 be opposed to each other with the winding center space 40K interposed therebetween, and be thus located on the straight line L. A reason for this is that this makes it easier for the positive electrode lead 51 to be welded to the external terminal 20 and also makes it easier for the negative electrode lead 52 to be welded to the cover part 12 in a state in which the cover part 12 is set upright relative to the container part 11, in the process of forming the outer package can 10 using the container part 11 and the cover part 12.

The negative electrode lead 52 may be coupled to the negative electrode 42 in the outermost wind, in the innermost wind, or in the middle of the winding between the outermost wind and the innermost wind. FIG. 2 illustrates a case where the negative electrode lead 52 is coupled to the negative electrode 42 in the outermost wind.

Note that the negative electrode lead 52 is physically separate from the negative electrode current collector 42A and is thus provided separately from the negative electrode current collector 42A. However, the negative electrode lead 52 may be physically continuous with the negative electrode current collector 42A and may thus be provided integrally with the negative electrode current collector 42A.

### [Sealant]

The sealant 60 is an insulating member that covers the periphery of the positive electrode lead 51 in part, as illustrated in FIG. 2. The sealant 60 has a tube-shaped structure. The sealant 60 includes one or more of insulating materials including, without limitation, a polymer compound having an insulating property. Examples of the insulating materials include polyimide.

Note that the sealant 60 may be omitted if the positive electrode lead 51 is separated (insulated) from each of the outer package can 10 (the container part 11 and the cover part 12) and the battery device 40 (the negative electrode 42).

The insulating film 70 is an insulating member disposed between the cover part 12 and the positive electrode lead 51, as illustrated in FIG. 2. Here, the insulating film 70 is ring-shaped in a plan view, and has a through hole at a location corresponding to the through hole 12K. Details of a material included in the insulating film 70 are similar to the details of the material included in the sealant 60. Note that the material included in the sealant 60 and the material included in the insulating film 70 may be the same as or different from each other.

Here, the insulating film 70 has an adhesive layer (not illustrated) on one surface, and is thus adhered to either the cover part 12 or the positive electrode lead 51 via the adhesive layer. Alternatively, the insulating film 70 may have respective adhesive layers (not illustrated) on both surfaces, and may thus be adhered to both the cover part 12 and the positive electrode lead 51 via the respective adhesive layers.

Note that the insulating film 70 may be omitted if the positive electrode lead 51 is separated (insulated) from the outer package can 10 (the container part 11).

Note that the secondary battery may further include one or more of other unillustrated components.

For example, the secondary battery includes a safety valve mechanism. The safety valve mechanism is a mechanism that cuts off electrical coupling between the outer package can 10 and the battery device 40 (the negative electrode 42) if an internal pressure of the outer package can 10 reaches a certain level or higher. Specific examples of a factor that causes the internal pressure of the outer package can 10 to reach the certain level or higher include a case where a short circuit occurs inside the secondary battery and a case where the secondary battery is heated from outside. A placement location of the safety valve mechanism is not particularly limited. In particular, the placement location of the safety valve mechanism is preferably a location on either the upper bottom part M1 or the lower bottom part M2, and is more preferably a location on the lower bottom part M2 to which no external terminal 20 is provided.

Further, the secondary battery includes an additional insulating film. The additional insulating film is disposed between the positive electrode lead 51 and the battery device 40, that is, between the sealant 60 and the battery device 40, and thus suppresses contact between the positive electrode lead 51 and the negative electrode 42. The additional insulating film is also disposed between the battery device 40 and the outer package can 10 (the lower bottom part M2), and thus suppresses contact between the outer package can 10 and the lower bottom part M2. The additional insulating film has a configuration similar to that of the insulating film 70.

Note that the outer package can 10 is provided with a cleavage valve. The cleavage valve cleaves to release the internal pressure of the outer package can 10 in a case where the internal pressure reaches a certain level or higher. A placement location of the cleavage valve is not particularly limited. In particular, as with the placement location of the safety valve mechanism described above, the placement location of the cleavage valve is preferably a location on either the upper bottom part M1 or the lower bottom part M2, and is more preferably a location on the lower bottom part M2.

Upon charging of the secondary battery, in the battery device 40, lithium is extracted from the positive electrode 41, and the extracted lithium is inserted into the negative electrode 42 via the electrolytic solution. Upon discharging of the secondary battery, in the battery device 40, lithium is extracted from the negative electrode 42, and the extracted lithium is inserted into the positive electrode 41 via the electrolytic solution. Upon the charging and the discharging, lithium is inserted and extracted in an ionic state.

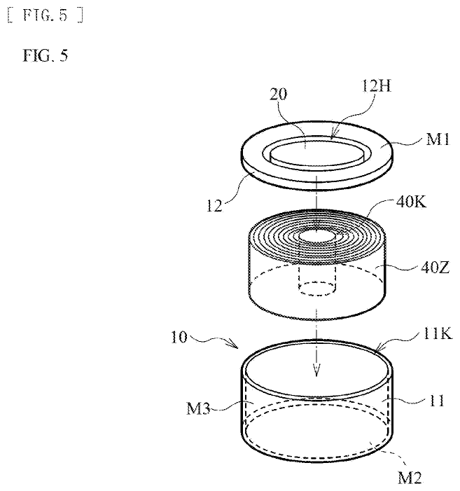

FIG. 5 illustrates a perspective configuration of the outer package can 10 to be used in the process of manufacturing the secondary battery, and corresponds to FIG. 1. FIG. 6 illustrates a sectional configuration of the outer package can 10 for describing the process of manufacturing the secondary battery, and corresponds to FIG. 2.

Note that FIG. 5 illustrates a state where the cover part 12 is yet to be welded to the container part 11 and is thus separate from the container part 11. FIG. 6 illustrates a state where the cover part 12 is yet to be welded to the container part 11, and the cover part 12 is set upright relative to the container part 11.

In the following description, where appropriate, FIGS. 1 to 4 described already will be referred to in conjunction with FIGS. 5 and 6.

Here, as illustrated in FIG. 5, the container part 11 and the cover part 12 that are physically separate from each other are used to form the outer package can 10. The container part 11 is the container member in which the lower bottom part M2 and the sidewall part M3 are integrated with each other, and has the opening 11K. The cover part 12 is the cover member corresponding to the upper bottom part M1. The external terminal 20 is attached in advance, via the gasket 30, to the recessed part 12H provided in the cover part 12. The insulating film 70 is attached in advance to the cover part 12.

Alternatively, the lower bottom part M2 and the sidewall part M3 may be separate from each other, and the container part 11 may thus be prepared by welding the sidewall part M3 to the lower bottom part M2.

A mixture (a positive electrode mixture) including, for example, the positive electrode active material, the positive electrode binder, and the positive electrode conductor is put into a solvent such as an organic solvent, to thereby prepare a paste positive electrode mixture slurry. Thereafter, the positive electrode mixture slurry is applied on the two opposed surfaces of the positive electrode current collector 41A to thereby form the positive electrode active material layers 41B. Thereafter, the positive electrode active material layers 41B may be compression-molded by means of, for example, a roll pressing machine. In this case, the positive electrode active material layers 41B may be heated. The positive electrode active material layers 41B may be compression-molded multiple times. In this manner, the positive electrode 41 is fabricated.

The negative electrode 42 is fabricated in accordance with a procedure similar to the procedure of fabricating the positive electrode 41. For example, a mixture (a negative electrode mixture) including, for example, the negative electrode active material, the negative electrode binder, and the negative electrode conductor is put into a solvent such as an organic solvent, to thereby prepare a paste negative electrode mixture slurry. Thereafter, the negative electrode mixture slurry is applied on the two opposed surfaces of the negative electrode current collector 42A to thereby form the negative electrode active material layers 42B. Thereafter, the negative electrode active material layers 42B may be compression-molded by means of, for example, a roll pressing machine. In this manner, the negative electrode 42 is fabricated.

The electrolyte salt is put into the solvent. The electrolyte salt is thereby dispersed or dissolved in the solvent. Thus, the electrolytic solution is prepared.

First, by means of a welding method such as a resistance welding method, the positive electrode lead 51 covered at the periphery thereof in part by the sealant 60 is coupled to the positive electrode 41 (the positive electrode current collector 41A), and the negative electrode lead 52 is coupled to the negative electrode 42 (the negative electrode current collector 42A).

Thereafter, the positive electrode 41 with the positive electrode lead 51 coupled thereto and the negative electrode 42 with the negative electrode lead 52 coupled thereto are stacked on each other with the separator 43 interposed therebetween, following which the stack of the positive electrode 41, the negative electrode 42, and the separator 43 is wound to thereby fabricate a wound body 40Z, as illustrated in FIG. 5. The wound body 40Z has a configuration similar to that of the battery device 40 except that the positive electrode 41, the negative electrode 42, and the separator 43 are each unimpregnated with the electrolytic solution. Note that FIG. 5 omits the illustration of each of the positive electrode lead 51 and the negative electrode lead 52 to simplify contents of illustration.

Thereafter, the wound body 40Z with the positive electrode lead 51 and the negative electrode lead 52 each coupled thereto is placed into the container part 11 through the opening 11K. Thereafter, the cover part 12 with the external terminal 20 attached thereto via the gasket 30 and the insulating film 70 attached thereto is placed on the container part 11. In this case, as illustrated in FIG. 6, the cover part 12 is set upright relative to the container part 11, using the container part 11 as a support stage.

In a case of setting the cover part 12 upright relative to the container part 11, it is preferable to make the cover part 12 stand substantially erect. A reason for this is that this allows the cover part 12 to self-stand with use of the container part 11 as a support stage, and allows the cover part 12 to be out of the way of the opening 11K. Alternatively, the cover part 12 may be tilted.

Thereafter, with the cover part 12 set upright relative to the container part 11, the positive electrode lead 51 is coupled to the external terminal 20 via the through hole 12K, and the negative electrode lead 52 (the tip part 52B) is coupled to the cover part 12, by means of a welding method such as a resistance welding method.

In this case, because the cover part 12 is set upright relative to the container part 11, it is possible to weld the positive electrode lead 51 to the external terminal 20 in a state in which sufficient spaces are provided on opposite sides of the cover part 12 with the external terminal 20 attached thereto. This makes it easier for two welding electrodes to be placed in the spaces on the opposite sides of the cover part 12 (the external terminal 20), and makes it easier for the two electrodes to be opposed to each other with the external terminal 20 and the positive electrode lead 51 interposed therebetween. As a result, it becomes easier for the positive electrode lead 51 to be welded to the external terminal 20 using the two electrodes, which makes it easier for the positive electrode lead 51 to be coupled to the external terminal 20 by surface coupling.

Further, for a similar reason, it becomes easier for two welding electrodes to be disposed in the spaces on the opposite sides of the cover part 12, and it becomes easier for the two electrodes to be opposed to each other with the cover part 12 and the negative electrode lead 52 (the tip part 52B) interposed therebetween. As a result, it becomes easier for the negative electrode lead 52 to be welded to the cover part 12 using the two electrodes, which makes it easier for the negative electrode lead 52 to be joined to the cover part 12 by surface joining.

In this manner, the wound body 40Z (the positive electrode 41) contained inside the container part 11 and the external terminal 20 attached to the cover part 12 are coupled to each other via the positive electrode lead 51. Further, the wound body 40Z (the negative electrode 42) and the cover part 12 are coupled to each other via the negative electrode lead 52. This makes it possible to keep a state in which the cover part 12 is set upright relative to the container part 11, even in a state in which the wound body 40Z (the positive electrode 41) and the external terminal 20 are coupled to each other via the positive electrode lead 51, and the wound body 40Z (the negative electrode 42) and the cover part 12 are coupled to each other via the negative electrode lead 52. Note that FIG. 6 omits the illustration of the sealant 60 for easy viewing of a state of the positive electrode lead 51.

The wording “setting the cover part 12 upright relative to the container part 11” means placing the cover part 12 to be substantially orthogonal to a bottom surface of the container part 11 as is apparent from FIG. 6, in order for the cover part 12 to be out of the way of the opening 11K. Accordingly, the cover part 12 is supported by the container part 11, which allows a state in which the cover part 12 is set upright relative to the container part 11 to be kept even after coupling of the positive electrode lead 51 to the external terminal 20 and after coupling of the negative electrode lead 52 to the cover part 12.

In this case, by making the length of the positive electrode lead 51 sufficiently large, the positive electrode lead 51 is prevented from being under excessive tension even if the cover part 12 is set upright relative to the container part 11, which suppresses damage to the positive electrode lead 51 such as breakage of the positive electrode lead 51. Similarly, by making the length of the negative electrode lead 52 sufficiently large, the negative electrode lead 52 is prevented from being under excessive tension even if the cover part 12 is set upright relative to the container part 11, which prevents damage to the negative electrode lead 52.

Thereafter, the electrolytic solution is injected into the container part 11 through the opening 11K. In this case, the cover part 12 is out of the way of the opening 11K even if the cover part 12 is set upright relative to the container part 11, as described above, which makes it easier for the electrolytic solution to be injected into the container part 11 through the opening 11K. The wound body 40Z (including the positive electrode 41, the negative electrode 42, and the separator 43) is thereby impregnated with the electrolytic solution. Thus, the battery device 40 which is the wound electrode body is fabricated.

Thereafter, the cover part 12 is tilted along an arrow R, that is, the cover part 12 is so tilted as to get closer to the container part 11, and the opening 11K is thereby shielded using the cover part 12, following which the cover part 12 is welded to the container part 11 by means of a welding method such as a laser welding method. In this case, the positive electrode lead 51 is folded into a state of being folded back as illustrated in FIG. 2. In this manner, the outer package can 10 is formed, and the components including, without limitation, the battery device 40 are sealed in the outer package can 10. The secondary battery is thus assembled.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state. The secondary battery is thus completed.

According to the secondary battery, the positive electrode lead 51 is so coupled to the positive electrode 41 as to protrude from the battery device 40 toward the cover part 12 and is coupled to the external terminal 20, the negative electrode lead 52 is so coupled to the negative electrode 42 as to protrude from the battery device 40 toward the cover part 12 and is coupled to the cover part 12, and the tip part 52B of the negative electrode lead 52 is bent in the direction approaching the winding center space 40K and is coupled to the cover part 12. This makes it possible to achieve superior manufacturing stability of the secondary battery for the following reasons.

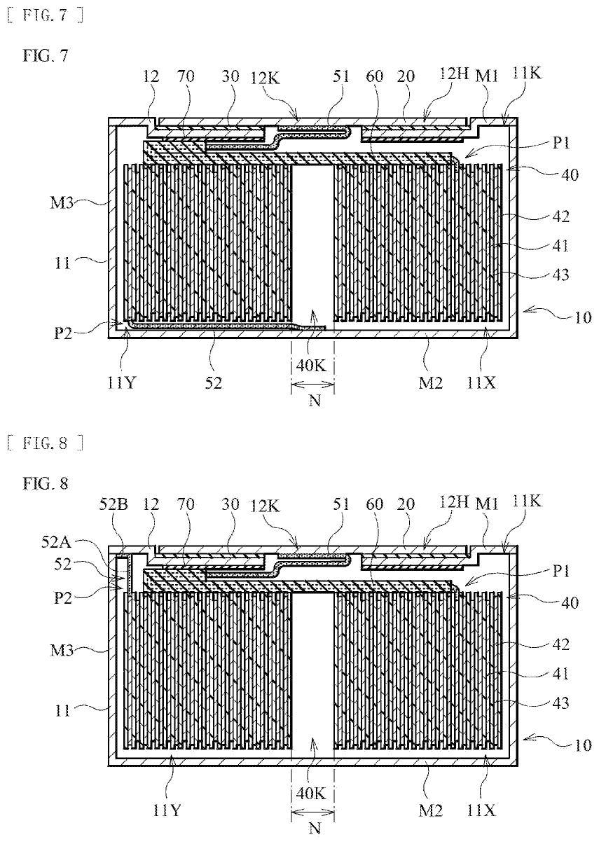

FIG. 7 illustrates a sectional configuration of a secondary battery of a first comparative example, and corresponds to FIG. 2. FIG. 8 illustrates a sectional configuration of a secondary battery of a second comparative example, and corresponds to FIG. 2.

As illustrated in FIG. 7, the secondary battery of the first comparative example has a configuration similar to that of the secondary battery of the present embodiment, except that the negative electrode lead 52 is so coupled to the negative electrode 42 as to protrude from the battery device 40 toward a side opposite to the cover part 12, i.e., downward, and the negative electrode lead 52 is coupled to the container part 11 (the lower bottom part M2). That is, the secondary battery of the first comparative example has a configuration substantially similar to that of the secondary battery disclosed in Japanese Unexamined Patent Application Publication (Published Japanese Translation of PCT Application) No. JP2012-517658).

As illustrated in FIG. 8, the secondary battery of the second comparative example has a configuration similar to that of the secondary battery of the present embodiment, except that the tip part 52B is bent in the direction away from the winding center space 40K, and the tip part 52B is in contact with the container part (the sidewall part M3). That is, the secondary battery of the second comparative example has a configuration substantially similar to that of the secondary battery disclosed in Japanese Unexamined Patent Application Publication No. 2008-262826.

In the secondary battery of the first comparative example, the negative electrode lead 52 is so coupled to the negative electrode 42 as to protrude downward from the battery device 40, which prevents creeping up of the electrolytic solution along the negative electrode lead 52 from occurring easily. As a result, in the process of manufacturing the secondary battery (the process of forming the outer package can 10 using the container part 11 and the cover part 12), it becomes easier for the cover part 12 to be welded to the container part 11, which makes it easier for the container part 11 to be sealed by the cover part 12 by means of a welding method.

More specifically, in a case where the negative electrode lead 52 is so coupled to the negative electrode 42 as to protrude upward from the battery device 40, a phenomenon occurs easily in which the electrolytic solution in the battery device 40 creeps up along the negative electrode lead 52 to reach the container part 11 (the sidewall part M3), that is, creeping up of the electrolytic solution along the negative electrode lead 52 occurs easily. Occurrence of such creeping up of the electrolytic solution causes the sidewall part M3 to dissolve or corrode easily due to contact with the electrolytic solution. This causes the electrolytic solution to be unintentionally interposed between the container part 11 and the cover part 12 easily in the process of forming the outer package can 10. As a result, it becomes difficult for the cover part 12 to be welded to the container part 11, which makes it difficult for the container part 11 to be sealed using the cover part 12.

In contrast, in a case where the negative electrode lead 52 is so coupled to the negative electrode 42 as to protrude downward from the battery device 40, the above-described creeping up of the electrolytic solution along the negative electrode lead 52 is prevented from occurring easily. In this case, the sidewall part M3 is prevented from dissolving or corroding easily. This prevents the electrolytic solution from being interposed between the container part 11 and the cover part 12 easily in the process of forming the outer package can 10. As a result, it becomes easier for the cover part 12 to be welded to the container part 11, which makes it easier for the container part 11 to be sealed by the cover part 12 by means of a welding method.

However, in the secondary battery of the first comparative example, because the negative electrode lead 52 is so coupled to the negative electrode 42 as to protrude downward from the battery device 40, the negative electrode lead 52 is coupled to the container part 11 (the lower bottom part M2). In this case, it becomes difficult for the negative electrode lead 52 to be welded to the lower bottom part M2, which makes it difficult for the negative electrode lead 52 to be coupled to the container part 11 by means of a welding method.

More specifically, in a case of coupling the negative electrode lead 52 to the lower bottom part M2, it is necessary to weld the negative electrode lead 52 to the lower bottom part M2. Accordingly, in a case of welding the negative electrode lead 52 to the lower bottom part M2 by means of a resistance welding method, in order to place two welding electrodes to be opposed to each other with the lower bottom part M2 interposed therebetween, it is necessary to place one of the two electrodes inside the winding center space 40K.

Here, a sufficient space is present below the lower bottom part M2 (outside the container part 11), and accordingly, no issue is caused by placing a welding electrode below the lower bottom part M2. In contrast, no sufficient space is present, that is, only the winding center space 40K which is narrow is present, above the lower bottom part M2 (inside the container part 11), and a welding electrode thus has to be placed inside the winding center space 40K.

This makes it difficult to insert a welding electrode into the winding center space 40K. As a result, it becomes difficult for the negative electrode lead 52 to be welded to the lower bottom part M2, which makes it difficult for the negative electrode lead 52 to be coupled to the outer package can 10 by means of a welding method. In this case, in particular, as the inner diameter N of the winding center space 40K becomes smaller, it becomes more difficult to insert a welding electrode into the winding center space 40K, which makes it more difficult for the negative electrode lead 52 to be welded to the outer package can 10.

Based upon the foregoing, in the secondary battery of the first comparative example, it is easier for the container part 11 to be sealed by the cover part 12 by means of a welding method, but it is difficult for the negative electrode lead 52 to be coupled to the container part 11 (the lower bottom part M2) by means of a welding method. This makes it difficult to achieve superior manufacturing stability of the secondary battery.

In the secondary battery of the second comparative example, the negative electrode lead 52 is so coupled to the negative electrode 42 as to protrude upward from the battery device 40. In this case, it becomes easier for the negative electrode lead 52 to be welded to the cover part 12, which makes it easier for the negative electrode lead 52 to be coupled to the cover part 12 by means of a welding method, unlike in the secondary battery of the first comparative example in which the negative electrode lead 52 is so coupled to the negative electrode 42 as to protrude downward from the battery device 40.

More specifically, in a case where the negative electrode lead 52 is coupled to the cover part 12, in the process of forming the outer package can 10, it is possible to weld the cover part 12 to the container part 11 in a state in which the cover part 12 is set upright relative to the container part 11, as described above. In this case, as described with reference to FIG. 6, sufficient spaces are present on the opposite sides of the cover part 12 set upright relative to the container part 11, which makes it possible for two welding electrodes to be so placed in the spaces as to be opposed to each other with the cover part 12 interposed therebetween. As a result, it becomes easier for the negative electrode lead 52 to be welded to the cover part 12, which makes it easier for the negative electrode lead 52 to be coupled to the cover part 12 by means of a welding method.

However, in the secondary battery of the second comparative example, because the tip part 52B is bent in the direction away from the winding center space 40K, creeping up of the electrolytic solution along the negative electrode lead 52 occurs easily. As a result, it becomes difficult for the cover part 12 to be welded to the container part 11 in the process of forming the outer package can 10, which makes it difficult for the container part 11 to be sealed by the cover part 12 by means of a welding method.

More specifically, in a case where the tip part 52B is bent in the direction away from the winding center space 40K, when creeping up of the electrolytic solution along the negative electrode lead 52 occurs, the electrolytic solution creeps up along the tip part 52B. As a result, the electrolytic solution is guided in the direction away from the winding center space 40K, which causes the electrolytic solution to finally reach the container part 11 (the sidewall part M3) easily. In this case, in particular, because the tip part 52B is in contact with the sidewall part M3, it is easier for the electrolytic solution to reach the sidewall part M3. If the electrolytic solution reaches the sidewall part M3, it becomes difficult for the cover part 12 to be welded to the container part 11 due to, for example, dissolution of the sidewall part M3, which makes it difficult for the container part 11 to be sealed by the cover part 12 by means of a welding method, for the reason described above.

Based upon the foregoing, in the secondary battery of the second comparative example, it is easier for the negative electrode lead 52 to be coupled to the cover part 12 by means of a welding method, but it is difficult for the container part 11 to be sealed by the cover part 12 by means of a welding method. This makes it difficult to achieve superior manufacturing stability of the secondary battery, as with the secondary battery of the first comparative example.

In contrast, in the secondary battery of an embodiment, the negative electrode lead 52 is so coupled to the negative electrode 42 as to protrude upward from the battery device 40, and the negative electrode lead 52 is coupled to the cover part 12.

In this case, in the process of forming the outer package can 10, it is possible to weld the cover part 12 to the container part 11 in a state in which the cover part 12 is set upright relative to the container part 11, for the reason described above. This makes it possible to place two welding electrodes in sufficient spaces present on the opposite sides of the cover part 12 to allow the two welding electrodes to be opposed to each other with the cover part 12 interposed therebetween, when welding the cover part 12 to the container part 11. As a result, it becomes easier for the negative electrode lead 52 to be welded to the cover part 12, which makes it easier for the negative electrode lead 52 to be coupled to the cover part 12 by means of a welding method. In this case, in particular, it is unnecessary to place a welding electrode inside the winding center space 40K, which makes it easier for the negative electrode lead 52 to be welded to the cover part 12, regardless of the inner diameter N of the winding center space 40K.

Note that, because the negative electrode lead 52 is so coupled to the negative electrode 42 as to protrude upward from the battery device 40, creeping up of the electrolytic solution along the negative electrode lead 52 can occur for the reason described above.

However, the tip part 52B is not bent away from the winding center space 40K, and is bent in the direction approaching the winding center space 40K. In this case, even if creeping up of the electrolytic solution along the negative electrode lead 52 occurs, it becomes easier for the electrolytic solution to be guided in the direction approaching the winding center space 40K. This prevents the electrolytic solution from finally reaching the container part 11 (the sidewall part M3) easily, and thus prevents the sidewall part M3 from dissolving or corroding easily. In this case, in particular, the tip part 52B is separated from the sidewall part M3, which further prevents the electrolytic solution from reaching the sidewall part M3 easily. As a result, it becomes easier for the cover part 12 to be welded to the container part 11, which makes it easier for the container part 11 to be sealed by the cover part 12 by means of a welding method.

Based upon the foregoing, in the secondary battery of an embodiment, unlike in the secondary battery of the first comparative example and the secondary battery of the second comparative example, it is easier for the negative electrode lead 52 to be coupled to the cover part 12 by means of a welding method, and it is easier for the container part 11 to be sealed by the cover part 12 by means of the welding method. This makes it possible to achieve superior manufacturing stability of the secondary battery.

In this case, in particular, it is possible to improve the manufacturing stability even if the secondary battery is a flat and columnar secondary battery, that is, a secondary battery referred to by a term such as the coin type or the button type, thus being a small-sized secondary battery which is highly constrained in terms of size.

In particular, the negative electrode lead 52 may be separated from the container part 11 (the sidewall part M3). This further prevents the electrolytic solution from reaching the sidewall part M3 easily even if creeping up of the electrolytic solution along the negative electrode lead 52 occurs, as described above. Accordingly, it is possible to achieve higher effects.

In this case, the positive electrode 41, the negative electrode 42, and the separator 43 may be wound in such a manner that the separator 43 is disposed in the outermost wind, and the negative electrode lead 52 may thus be separated from the container part 11 (the sidewall part M3) with the separator 43 in the outermost wind interposed therebetween. This prevents the battery device 40 from being damaged easily even if the secondary battery undergoes shock upon being dropped, for example. In addition, this increases the amount of the electrolytic solution held by the entire battery device 40. Accordingly, it is possible to achieve further higher effects.

Further, the tip part 52B may be so disposed as not to overlap with the positive electrode lead 51 in a state of being separated from the positive electrode lead 51. This suppresses contact between the positive electrode lead 51 and the negative electrode lead 52 (the tip part 52B). Accordingly, it is possible to achieve higher effects.

Further, the coupling position P1 of the positive electrode lead 51 to the positive electrode 41 and the coupling position P2 of the negative electrode lead 52 to the negative electrode 42 may be opposed to each other with the winding center space 40K interposed therebetween. This makes it easier for the negative electrode lead 52 to be welded to the cover part 12 in a state in which the cover part 12 is set upright relative to the container part 11. Accordingly, it is possible to achieve higher effects. In this case, it becomes easier for the positive electrode lead 51 to be welded to the external terminal 20 in a state in which the cover part 12 is set upright relative to the container part 11. Accordingly, it is possible to achieve further higher effects.

Further, the positive electrode lead 51 may be extended from the region X to the region Y. This increases the length margin of the positive electrode lead 51. It thus becomes easier for the positive electrode lead 51 to be welded to the cover part 12 in a state in which the cover part 12 is set upright relative to the container part 11. Accordingly, it is possible to achieve higher effects.

Further, the positive electrode lead 51 may be folded back once or more between the battery device 40 and the external terminal 20. This provides the length margin of the positive electrode lead 51. It thus becomes easier for the cover part 12 to be set upright relative to the container part 11, while damage to the positive electrode lead 51 such as breakage of the positive electrode lead 51 is suppressed. Accordingly, it is possible to achieve higher effects.

Further, the relationship represented by Expression (1) may be satisfied regarding the length of the positive electrode lead 51 between the battery device 40 and the external terminal 20. This secures the length of the positive electrode lead 51. It thus becomes easier for the cover part 12 to be stably set upright relative to the container part 11. Accordingly, it is possible to achieve higher effects.

Further, the cover part 12 may include the recessed part 12H, and the external terminal 20 may be disposed inside the recessed part 12H. This reduces the height H of the secondary battery, and results in an increase in energy density per unit volume. Accordingly, it is possible to achieve higher effects.

Further, the outer package can 10 may include the container part 11 and the cover part 12, and the cover part 12 may be welded to the container part 11 at the opening 11K. This increases the device space volume inside the outer package can 10, and results in an increase in energy density per unit volume. Accordingly, it is possible to achieve higher effects.

Further, the secondary battery may include a lithium-ion secondary battery. This makes it possible to obtain a sufficient battery capacity stably through the use of insertion and extraction of lithium. Accordingly, it is possible to achieve higher effects.

The configuration of the secondary battery is appropriately modifiable including as described below according to an embodiment. Note that any two or more of the following series of modifications may be combined with each other.

In FIG. 2, the intermediate part 52A of the negative electrode lead 52 extends straight, and the intermediate part 52A is thus not bent. However, the intermediate part 52A may be bent without extending straight. A direction in which the intermediate part 52A is to be bent is not particularly limited, and may be the direction away from the winding center space 40K, the direction approaching the winding center space 40K, or both of the directions. The number of times the intermediate part 52A is to be bent is not particularly limited.

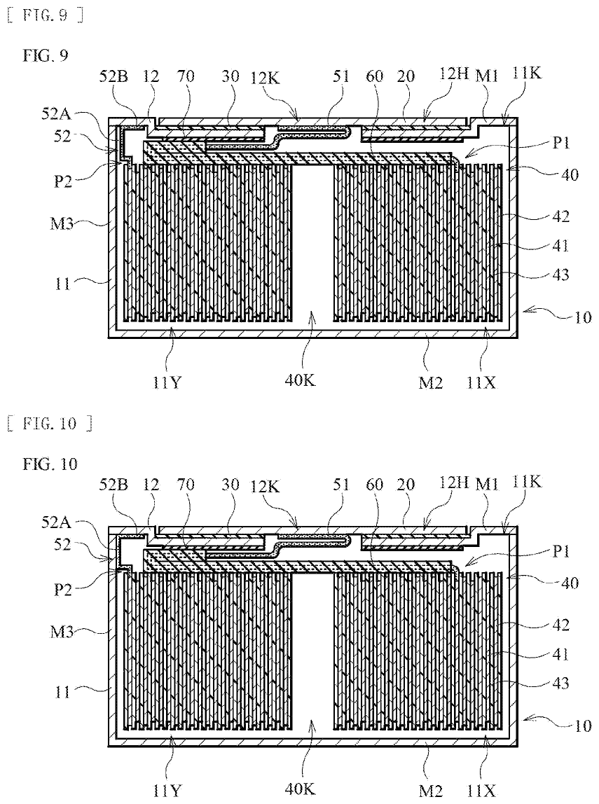

As illustrated in FIG. 9 corresponding to FIG. 2, the intermediate part 52A may be bent in the direction away from the winding center space 40K between the battery device 40 and the cover part 12, and the negative electrode lead 52 may thus be folded back once or more. Here, the intermediate part 52A is so bent as not to be in contact with the container part 11 (the sidewall part M3), thus being separated from the sidewall part M3. Further, the negative electrode lead 52 is folded back once.

In this case, a length margin of the negative electrode lead 52 increases, while dissolution or corrosion of the sidewall part M3 due to creeping up of the electrolytic solution along the negative electrode lead 52 is suppressed. This makes it further easier for the cover part 12 to be set upright relative to the container part 11. Accordingly, it is possible to achieve higher effects.

In particular, in a case where the intermediate part 52A is bent in the direction away from the winding center space 40K, the intermediate part 52A is away from the positive electrode lead 51, as compared with a case where the intermediate part 52A is bent in the direction approaching the winding center space 40K. This suppresses contact between the negative electrode lead 52 (the intermediate part 52A) and the positive electrode lead 51. It is thus possible to achieve higher effects in this regard.

In a case where the intermediate part 52A is bent in the direction away from the winding center space 40K, and the negative electrode lead 52 is thus folded back, the intermediate part 52A may be in contact with the container part 11 (the sidewall part M3), as illustrated in FIG. 10 corresponding to FIG. 9. In this case also, the length margin of the negative electrode lead 52 increases, while dissolution or corrosion of the sidewall part M3 due to creeping up of the electrolytic solution along the negative electrode lead 52 is suppressed. Accordingly, it is possible to achieve similar effects.

In a case where the intermediate part 52A is in contact with the sidewall part M3, the electrolytic solution creeps up along the intermediate part 52A, and the electrolytic solution can thus reach the sidewall part M3. However, if the tip part 52B is bent in the direction approaching the winding center space 40K, even if the electrolytic solution creeps up along the intermediate part 52A, the electrolytic solution creeps up along the tip part 52B after the intermediate part 52A, which makes it easier for the electrolytic solution to be finally guided away from the sidewall part M3. As a result, as compared with a case where the tip part 52B is bent in the direction away from the winding center space 40K, the sidewall part M3 is prevented from dissolving or being damaged easily even if creeping up of the electrolytic solution along the negative electrode lead 52 occurs, which helps to prevent occurrence of an issue due to such creeping up of the electrolytic solution.

Note that, to sufficiently suppress occurrence of an issue due to creeping up of the electrolytic solution, the intermediate part 52A is preferably separated from the sidewall part M3 as illustrated in FIG. 9.

In a case where the intermediate part 52A is bent and the negative electrode lead 52 is thus folded back, as illustrated in FIGS. 9 and 10, a crease may be provided at a location where the negative electrode lead 52 is folded back, that is, a location where the negative electrode lead 52 is bent. The crease may be a fold provided by the intermediate part 52A being folded in advance, or a shallow groove provided at a bending location in advance. The number of the creases is not particularly limited, and may be chosen as desired.

In this case, when the cover part 12 is tilted to shield the opening 11K from a state in which the cover part 12 is set upright relative to the container part 11, the negative electrode lead 52 (the intermediate part 52A) is automatically bent at the crease, which makes it easier for the intermediate part 52A to be bent into a desired bent state. This suppresses bending of the negative electrode lead 52 into an unintended bent state. Accordingly, it is possible to achieve higher effects.

The wording “bending of the negative electrode lead 52 into an unintended bent state” means cases where the negative electrode lead 52 is bent as described below. A first case is where, although the intermediate part 52A is to be bent in a direction away from the external terminal 20, the intermediate part 52A is bent in the direction approaching the external terminal 20. A second case is where, although the intermediate part 52A is to be so bent as not to come into contact with the container part 11 (the sidewall part M3), the intermediate part 52A is so bent as to come into contact with the sidewall part M3. A third case is where, although the intermediate part 52A is to be so bent as not to come into contact with the positive electrode 41, the intermediate part 52A is so bent as to come into contact with the positive electrode 41.

Similarly, in a case where the positive electrode lead 51 is bent between the battery device 40 and the external terminal 20, and the positive electrode lead 51 is thus folded back, a crease may be provided at a location where the positive electrode lead 51 is bent. Details of the crease are as described above.

In this case, it becomes easier for the positive electrode lead 51 to be bent into a desired bent state, for a reason similar to that in the case where a crease is provided on the negative electrode lead 52. This suppresses bending of the positive electrode lead 51 into an unintended bent state. Accordingly, it is possible to achieve higher effects.

The wording “bending of the positive electrode lead 51 into an unintended bent state” means cases where the positive electrode lead 51 is bent as described below. A first case is where, although the positive electrode lead 51 is to be so bent as not to come into contact with the outer package can 10 (the container part 11 and the cover part 12), the positive electrode lead 51 is so bent as to come into contact with the outer package can 10. A second case is where, although the positive electrode lead 51 is to be so bent as not to come into contact with the negative electrode 42, the positive electrode lead 51 is so bent as to come into contact with the negative electrode 42.

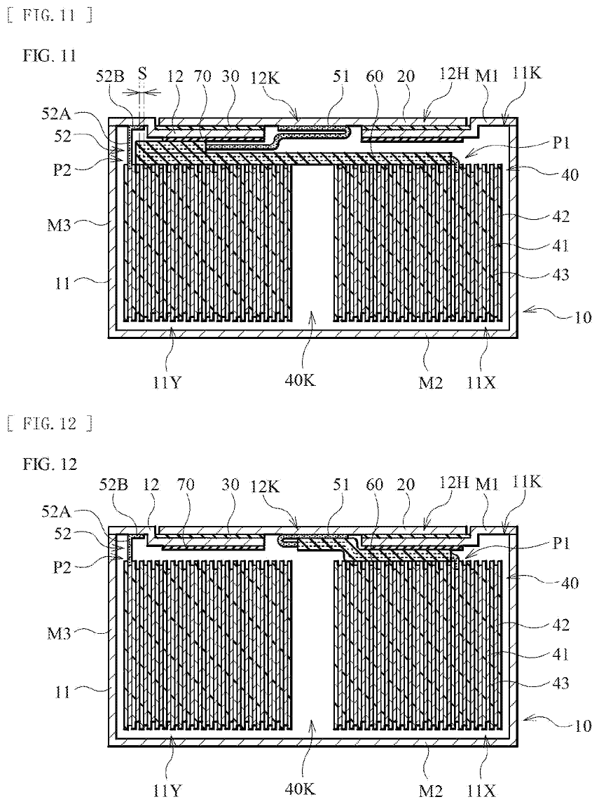

In FIG. 2, the tip part 52B is so disposed as not to overlap with the positive electrode lead 51 in a state in which the tip part 52B is separated from the positive electrode lead 51. However, as illustrated in FIG. 11 corresponding to FIG. 2, the tip part 52B may be so disposed as to overlap with the positive electrode lead 51 in a state in which the tip part 52B is separated from the positive electrode lead 51. An overlap distance S between the tip part 52B and the positive electrode lead 51 is not particularly limited, and may be chosen as desired.

In this case also, the negative electrode lead 52 (the tip part 52B) is insulated from the positive electrode lead 51 via the sealant 60. Accordingly, it is possible to achieve similar effects. In this case, in particular, if the positive electrode lead 51 is further extended in the region Y in order to make the tip part 52B overlap with the positive electrode lead 51, the length margin of the positive electrode lead 51 further increases. Accordingly, it is possible to achieve further higher effects.

Note that, to suppress unintended contact of the negative electrode lead 52 (the tip part 52B) with the positive electrode lead 51 due to, for example, damage to the sealant 60, the tip part 52B is preferably so disposed as not to overlap with the positive electrode lead 51.

In FIG. 2, the positive electrode lead 51 is extended from the region X to the region Y, and the positive electrode lead 51 is thus folded back in the region Y. However, a range of placement (extension) of the positive electrode lead 51 is not particularly limited.

As illustrated in FIG. 12 corresponding to FIG. 2, the positive electrode lead 51 may not be extended to the region Y, and may thus not be folded back in the region Y. In this case also, the advantages based on the configuration of the negative electrode lead 52 described above are obtained. Accordingly, it is possible to achieve similar effects.

In a case where the positive electrode lead 51 is not extended to the region Y, there is a possibility that the length margin of the positive electrode lead 51 is not secured. In this case, in a state in which the cover part 12 is set upright relative to the container part 11 in the process of forming the outer package can 10, the positive electrode lead 51 may not be welded to the external terminal 20, while the negative electrode lead 52 is welded to the cover part 12. Accordingly, after the opening 11K of the container part 11 is shielded using the cover part 12, the positive electrode lead 51 may be welded to the external terminal 20 afterward by means of a method such as a laser welding method.

Note that, to sufficiently couple the positive electrode lead 51 to the external terminal 20 by means of a welding method, it is preferable that the positive electrode lead 51 be extended to the region Y and be folded back in the region Y, as illustrated in FIG. 2. A reason for this is that the length margin of the positive electrode lead 51 is secured, which makes it possible to weld the positive electrode lead 51 to the external terminal 20 in a state in which the cover part 12 is set upright relative to the container part 11.

In FIG. 3, the secondary battery includes one positive electrode lead 51. However, the number of the positive electrode leads 51 is not particularly limited, and may be two or more.

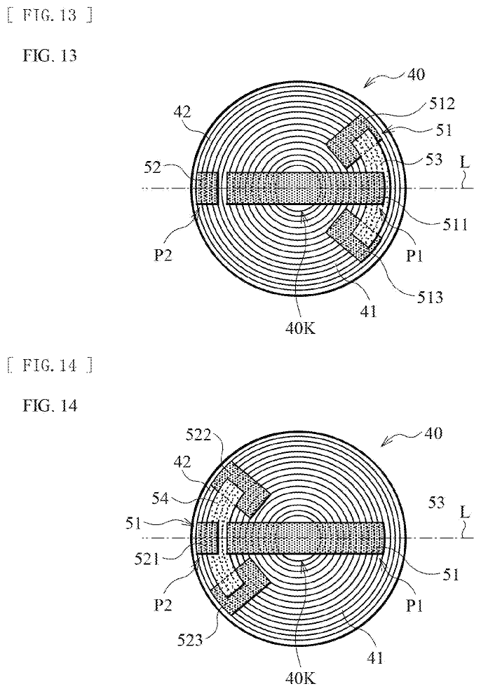

As illustrated in FIG. 13 corresponding to FIG. 3, the secondary battery may include three positive electrode leads 51 (511, 512, and 513), and the secondary battery may further include an electric coupling lead 53. In FIG. 13, the positive electrode leads 511 to 513 are each shaded darkly, and the electric coupling lead 53 is shaded lightly.

The positive electrode leads 512 and 513 are disposed to be opposed to each other with the positive electrode lead 511 interposed therebetween. The positive electrode lead 511 is directly coupled to the external terminal 20, whereas the positive electrode leads 512 and 513 are each coupled to the positive electrode lead 511 via the electric coupling lead 53, thus being indirectly coupled to the external terminal 20. The electric coupling lead 53 is a first electric coupling member that couples each of the positive electrode leads 512 and 513 to the positive electrode lead 511. The positive electrode leads 511 to 513 are thus coupled to each other via the electric coupling lead 53.

The electric coupling lead 53 is not particularly limited in configuration (planar shape). Here, the electric coupling lead 53 is curved along a winding direction of the positive electrode 41. Further, the electric coupling lead 53 is coupled to a bottom surface of the positive electrode lead 511, and is coupled to respective top surfaces of the positive electrode leads 512 and 513. Details of a material included in the electric coupling lead 53 are similar to the details of the material included in each of the positive electrode leads 511 to 513. Note that the material included in the electric coupling lead 53 and the material included in each of the positive electrode leads 511 to 513 may be the same as or different from each other.

In this case, the increase in the number of the positive electrode leads 51 results in a decrease in electric resistance of the battery device 40 (the positive electrode 41). Accordingly, it is possible to achieve higher effects. Needless to say, the number of the positive electrode leads 51 is not limited to three, and may be two or four or more.

As with the case described regarding the positive electrode lead 51, although the secondary battery includes one negative electrode lead 52 in FIG. 3, the number of the negative electrode leads 52 may be two or more.

As illustrated in FIG. 14 corresponding to FIG. 3, the secondary battery may include three negative electrode leads 52 (521, 522, and 523) and an electric coupling lead 54. In FIG. 14, the negative electrode leads 521 to 523 are each shaded darkly, and the electric coupling lead 54 is shaded lightly.

Respective configurations of the negative electrode leads 521 to 523 and the electric coupling lead 54 are substantially similar to the respective configurations of the positive electrode leads 511 to 513 and the electric coupling lead 53. That is, the electric coupling lead 54 is a second electric coupling member that couples each of the negative electrode leads 522 and 523 to the negative electrode lead 521. The negative electrode leads 521 to 523 are thus coupled to each other via the electric coupling lead 54.

In this case, the increase in the number of the negative electrode leads 52 results in a decrease in electric resistance of the battery device 40 (the negative electrode 42). Accordingly, it is possible to achieve higher effects. Needless to say, the number of the negative electrode leads 52 is not limited to three, and may be two or four or more.

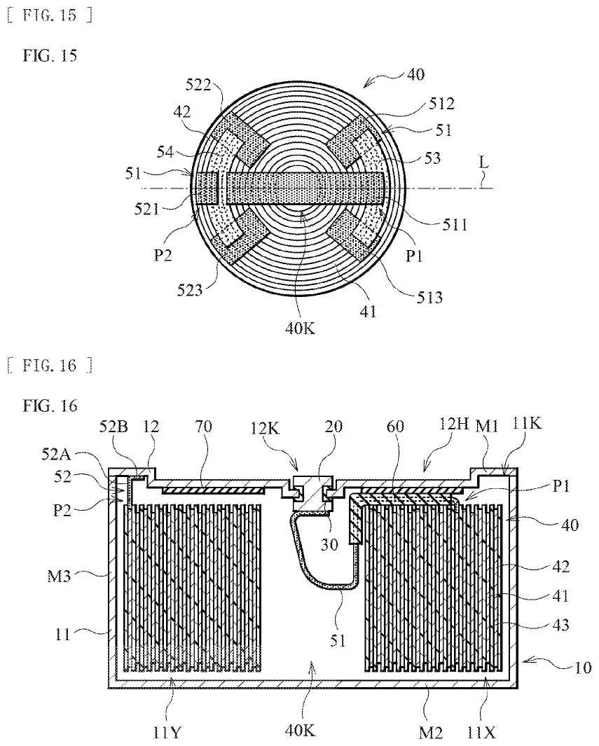

Needless to say, as illustrated in FIG. 15 corresponding to each of FIGS. 13 and 14, the secondary battery may include multiple positive electrode leads 51 (here, the three positive electrode leads 511 to 513), multiple negative electrode leads 52 (here, the three negative electrode leads 521 to 523), and the electric coupling leads 53 and 54. In this case, the electric resistance of the battery device 40 (the positive electrode 41 and the negative electrode 42) further decreases. Accordingly, it is possible to achieve further higher effects.

In FIG. 2, the outer package can 10 is used in which the flat external terminal 20 is provided outside the cover part 12 including the recessed part 12H. However, the configuration of the outer package can 10 is not particularly limited, and may be changed as desired.

As illustrated in FIG. 16 corresponding to FIG. 2, the outer package can 10 may be used in which the recessed part 12H that is two-level recessed (forms two steps) and has the through hole 12K is provided in the cover part 12, and the external terminal 20 extending from inside to outside the cover part 12 via the through hole 12K is provided on the cover part 12.

In this outer package can 10, the external terminal 20 is placed in the through hole 12K and fixed to the cover part 12 via the gasket 30. The external terminal 20 includes a small-outer-diameter portion placed in the through hole 12K and two large-outer-diameter portions disposed inside and outside the cover part 12. The two large-outer-diameter portions each have an outer diameter larger than an inner diameter of the through hole 12K. The external terminal 20 is thus prevented from falling off the cover part 12 with the help of a difference in outer diameter between the small-outer-diameter portion and the two large-outer-diameter portions.

The large-outer-diameter portion lying inside the cover part 12 is disposed inside the winding center space 40K. The positive electrode lead 51 is thus coupled to the large-outer-diameter portion in the winding center space 40K. The large-outer-diameter portion lying outside the cover part 12 is so disposed inside the recessed part 12H as not to protrude from the cover part 12. Note that a portion of the large-outer-diameter portion may protrude from the cover part 12, and a portion of the external terminal 20 may thus be disposed inside the recessed part 12H.

In this case also, the secondary battery is couplable to electronic equipment via the external terminal 20 (the external coupling terminal for the positive electrode 41) and the outer package can 10 (the external coupling terminal for the negative electrode 42). Accordingly, it is possible to achieve similar effects.

In FIG. 2, the positive electrode 41 is coupled to the external terminal 20 via the positive electrode lead 51, and the negative electrode 42 is coupled to the outer package can 10 (the cover part 12) via the negative electrode lead 52. Thus, the external terminal 20 serves as the external coupling terminal for the positive electrode 41, and the outer package can 10 serves as the external coupling terminal for the negative electrode 42.

However, although not specifically illustrated here, the positive electrode 41 may be coupled to the outer package can 10 via the positive electrode lead 51 serving as the second wiring line, and the negative electrode 42 may be coupled to the external terminal 20 via the negative electrode lead 52 serving as the first wiring line. Thus, the outer package can 10 may serve as the external coupling terminal for the positive electrode 41 serving as the second electrode, and the external terminal 20 may serve as the external coupling terminal for the negative electrode 42 serving as the first electrode.

In this case, to serve as the external coupling terminal for the negative electrode 42, the external terminal 20 includes one or more of electrically conductive materials including, without limitation, a metal material and an alloy material. Examples of the electrically conductive materials include iron, copper, nickel, stainless steel, an iron alloy, a copper alloy, and a nickel alloy. To serve as the external coupling terminal for the positive electrode 41, the outer package can 10 includes one or more of electrically conductive materials including, without limitation, a metal material and an alloy material. Examples of the electrically conductive materials include aluminum, an aluminum alloy, and stainless steel.

In this case also, the secondary battery is couplable to electronic equipment via the external terminal 20 (the external coupling terminal for the negative electrode 42) and the outer package can 10 (the external coupling terminal for the positive electrode 41). Accordingly, it is possible to achieve similar effects.

### EXAMPLES

Examples of the present technology are described below according to an embodiment.

### <Fabrication of Secondary Batteries>

As described below, a secondary battery (a lithium-ion secondary battery) of Example 1 was fabricated, and thereafter the secondary battery of Example 1 was evaluated for its performance. In this case, for comparison, secondary batteries of Comparative examples 1 and 2 were also fabricated to thereby also evaluate the secondary batteries of Comparative examples 1 and 2 for their performance.

### Example 1

As illustrated in FIGS. 1 to 4, a secondary battery of the button type corresponding to the secondary battery of the embodiment described above was fabricated.

### (Fabrication of Positive Electrode)

First, 91 parts by mass of the positive electrode active material (lithium cobalt oxide (LiCoO₂) which is a lithium compound (an oxide)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone which is an organic solvent), following which the solvent was stirred to thereby prepare a paste positive electrode mixture slurry. Thereafter, the positive electrode mixture slurry was applied on the two opposed surfaces of the positive electrode current collector 41A (a band-shaped aluminum foil having a thickness of 12 μm) by means of a coating apparatus, following which the applied positive electrode mixture slurry was dried to thereby form the positive electrode active material layers 41B. Lastly, the positive electrode active material layers 41B were compression-molded by means of a roll pressing machine. In this manner, the positive electrode 41 was fabricated.

### (Fabrication of Negative Electrode)

First, 95 parts by mass of the negative electrode active material (graphite which is a carbon material) and 5 parts by mass of the negative electrode binder (polyvinylidene difluoride) were mixed with each other to thereby obtain a negative electrode mixture. Thereafter, the negative electrode mixture was put into a solvent (N-methyl-2-pyrrolidone which is an organic solvent), following which the solvent was stirred to thereby prepare a paste negative electrode mixture slurry. Thereafter, the positive electrode mixture slurry was applied on the two opposed surfaces of the negative electrode current collector 42A (a band-shaped copper foil having a thickness of 15 μm) by means of a coating apparatus, following which the applied negative electrode mixture slurry was dried to thereby form the negative electrode active material layers 42B. Lastly, the negative electrode active material layers 42B were compression-molded by means of a roll pressing machine. In this manner, the negative electrode 42 was fabricated.

### (Preparation of Electrolytic Solution)

The electrolyte salt (lithium hexafluorophosphate (LiPF₆)) was added to the solvent (ethylene carbonate and diethyl carbonate), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. Thus, the electrolytic solution was prepared.

### (Assembly of Secondary Battery)

First, the positive electrode lead 51 (0.1 mm in thickness and 2.0 mm in width) including aluminum and covered in part at the periphery thereof by the sealant 60 (a polypropylene film) was welded to the positive electrode 41 (the positive electrode current collector 41A) by means of a resistance welding method. The sealant 60 had a tube shape and was 9.0 mm in outer diameter and 3.0 mm in inner diameter. In this case, a position of welding of the positive electrode lead 51 to the positive electrode 41 was adjusted to make the positive electrode lead 51 protrude from the battery device 40 toward the cover part 12 when the battery device 40 was fabricated in a later process.

Further, the negative electrode lead 52 (0.1 mm in thickness and 3.0 mm in width) including nickel was welded to the negative electrode 42 (the negative electrode current collector 42A) by means of a resistance welding method. In this case, a position of welding of the negative electrode lead 52 to the negative electrode 42 was adjusted to make the negative electrode lead 52 protrude from the battery device 40 toward the cover part 12 when the battery device 40 was fabricated in the later process.

Thereafter, the positive electrode 41 and the negative electrode 42 were stacked on each other with the separator 43 (a fine-porous polyethylene film having a thickness of 25 μm and a width of 4.0 mm) interposed therebetween, and the stack of the positive electrode 41, the negative electrode 42, and the separator 43 was wound about a jig having a cylindrical shape, following which the jig was removed. The wound body 40Z having a cylindrical shape and having the winding center space 40K was thereby fabricated. In this case, the positive electrode 41, the negative electrode 42, and the separator 43 were wound in such a manner that the separator 43 was disposed in the outermost wind and the negative electrode 42 was disposed on the outer side of the winding relative to the positive electrode 41. Further, an outer diameter of the jig was changed to thereby vary the inner diameter N (mm) of the winding center space 40K, as indicated in Table 1.

Thereafter, a ring-shaped underlay insulating film (a polyimide film, 0.1 mm in thickness) was placed, through the opening 11K, into the container part 11 having a cylindrical shape (0.15 mm in thickness) and including stainless steel (SUS316), following which the wound body 40Z was placed into the container part 11.

Thereafter, the cover part 12 (0.15 mm in thickness) having a disk shape and including stainless steel (SUS316) was placed on the container part 11. The cover part 12 was provided with the recessed part 12H (8.0 mm in inner diameter and 0.3 mm in depth) having the through hole 12K. The cover part 12 had the external terminal 20 (0.3 mm in thickness and 5.0 mm in outer diameter) having a disk shape and including aluminum attached thereto via the gasket 30 (a polyimide film, 0.1 mm in thickness). The cover part 12 also had the insulating film 70 having a ring shape (a polyimide film, 0.1 mm in thickness) attached thereto. In this case, the cover part 12 was set upright relative to the container part 11, using the container part 11 as a support stage.

Thereafter, with the cover part 12 set upright relative to the container part 11, the positive electrode lead 51 was welded to the external terminal 20 via the through hole 12K, and the negative electrode lead 52 was welded to the cover part 12, by means of a resistance welding method.

Thereafter, the electrolytic solution was injected into the container part 11 through the opening 11K. The wound body 40Z (including the positive electrode 41, the negative electrode 42, and the separator 43) was thereby impregnated with the electrolytic solution. In this manner, the battery device 40 was fabricated.

Lastly, the cover part 12 was tilted toward the container part 11 to thereby shield the opening 11K using the cover part 12, following which the cover part 12 was welded to the container part 11 by means of a laser welding method. In this manner, the outer package can 10 was formed using the container part 11 and the cover part 12, and the battery device 40 was sealed in the outer package can 10. The secondary battery having an outer diameter of 12.0 mm and a height of 6.0 mm was thus assembled.

### (Stabilization of Secondary Battery)

The secondary battery after being assembled was charged and discharged for one cycle in an ambient temperature environment (at a temperature of 23° C.). Upon the charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 3.0 V. Note that 0.1 C is a value of a current that causes the battery capacity (a theoretical capacity) to be completely discharged in 10 hours, and 0.05 C is a value of a current that causes the battery capacity to be completely discharged in 20 hours.

As a result, a film was formed on the surface of, for example, the negative electrode 42 to thereby electrochemically stabilize the state of the secondary battery. Thus, the secondary battery of the button type was completed.

### Comparative Example 1

In accordance with a procedure described below, a secondary battery of the button type corresponding to the secondary battery of the first comparative example illustrated in FIG. 7 was fabricated. The procedure of fabricating the secondary battery of Comparative example 1 was similar to the procedure of fabricating the secondary battery of Example 1 except for the following.

In a process of coupling the negative electrode lead 52, the negative electrode lead 52 was so welded to the negative electrode 42 as to protrude from the battery device 40 toward a direction opposite to the cover part 12, i.e., downward, by means of a resistance welding method, following which the negative electrode lead 52 was welded to the container part 11 (the lower bottom part M2) by means of a resistance welding method. In the case of welding the negative electrode lead 52 to the lower bottom part M2 by means of the resistance welding method, one of two welding electrodes was placed inside the winding center space 40K.

### Comparative Example 2

In accordance with a procedure described below, a secondary battery of the button type corresponding to the secondary battery of the second comparative example illustrated in FIG. 8 was fabricated. The procedure of fabricating the secondary battery of Comparative example 2 was similar to the procedure of fabricating the secondary battery of Example 1 except for the following.

In the process of coupling the negative electrode lead 52, with the cover part 12 set upright relative to the container part 11, the negative electrode lead 52 was welded to the negative electrode 42 in such a manner that the tip part 52B was bent in the direction away from the winding center space 40K and came into contact with the container part 11 (the sidewall part M3), by means of a resistance welding method.

The secondary batteries were evaluated for their performance (manufacturing stability). The evaluation revealed the results presented in Table 1. In this case, a welding test for the negative electrode lead 52 and a welding test for the outer package can 10 were performed as described below.

In the welding test for the negative electrode lead 52, the negative electrode lead 52 was welded to the cover part 12 or the container part 11 (the lower bottom part M2) by means of a resistance welding method to thereby fabricate the secondary battery. Thereafter, it was checked whether the negative electrode lead 52 was sufficiently coupled to the cover part 12 or the lower bottom part M2.

In this case, the number of test samples was set to 100, i.e., 100 secondary batteries were used for the welding test for the negative electrode lead 52, to thereby examine the number of secondary batteries in which the negative electrode lead 52 was not sufficiently coupled to the cover part 12 or the lower bottom part M2 (the number of the negative electrode leads 52 poorly welded). Specifically, in a case where the negative electrode lead 52 fell off the cover part 12 or the lower bottom part M2, it was determined that the negative electrode lead 52 was not sufficiently coupled to the cover part 12 or the lower bottom part M2. Even if the negative electrode lead 52 was coupled to the cover part 12 or the lower bottom part M2, in a case where the negative electrode lead 52 fell off the cover part 12 or the lower bottom part M2 due to vibration or shock, it was determined that the negative electrode lead 52 was not sufficiently coupled to the cover part 12 or the lower bottom part M2.

In the welding test for the outer package can 10, the cover part 12 was welded to the container part 11 by means of a laser welding method to thereby fabricate the secondary battery. Thereafter, it was checked whether the cover part 12 was sufficiently joined to the container part 11.

In this case, the number of test samples was set to 100, i.e., 100 secondary batteries were used for the welding test for the outer package can 10, to thereby examine the number of secondary batteries in which the cover part 12 was not sufficiently joined to the container part 11 (the number of the outer package cans 10 poorly welded). Specifically, in a case where the cover part 12 was not joined to the container part 11, and a gap thus developed between the cover part 12 and the container part 11, it was determined that the cover part 12 was not sufficiently joined to the container part 11. Even if the cover part 12 was joined to the container part 11, in a case where a gap developed between the cover part 12 and the container part 11 due to vibration or shock, it was determined that the cover part 12 was not sufficiently joined to the container part 11.

TABLE 1

| | Inner | Number of negative | Number of outer |
|---|---|---|---|
| | diameter N | electrode leads | package cans |
| | (mm) | poorly welded | poorly welded |
| Example 1 | 3.0 | 0 | 0 |
| | 2.0 | 0 | 0 |
| | 1.5 | 0 | 0 |
| | 1.0 | 0 | 0 |
| Comparative | 3.0 | 5 | 0 |
| example 1 | 2.0 | 15 | 0 |
| | 1.5 | 30 | 0 |
| | 1.0 | 80 | 0 |
| Comparative | 3.0 | 0 | 15 |
| example 2 | 2.0 | 0 | 12 |
| | 1.5 | 0 | 13 |
| | 1.0 | 0 | 17 |

Number of test samples for welding of negative electrode lead = 100
Number of test samples for welding of outer package can = 100

As indicated in Table 1, the manufacturing stability of the secondary battery varied greatly depending on the configuration of the secondary battery.

In a case where the tip part 52B was separated from the container part 11 (the sidewall part M3) but where the negative electrode lead 52 was so coupled to the negative electrode 42 as to protrude downward from the battery device 40 and was thus coupled to the container part 11 (the lower bottom part M2), i.e., in Comparative example 1, a so-called trade-off relationship was exhibited. That is, no creeping up of the electrolytic solution along the negative electrode lead 52 occurred, which prevented occurrence of poor welding of the outer package can 10. However, it became difficult for the negative electrode lead 52 to be welded to the lower bottom part M2 by means of a resistance welding method, which caused poor welding of the negative electrode lead 52 to occur. In this case, as the inner diameter N of the winding center space 40K became smaller, it became more difficult to place a welding electrode inside the winding center space 40K, which resulted in an increase in the number of the negative electrode leads 52 poorly welded.

Also in a case where the negative electrode lead 52 was so coupled to the negative electrode 42 as to protrude upward from the battery device 40 but where the tip part 52B was bent in the direction away from the winding center space 40K, i.e., in Comparative example 2, a trade-off relationship was exhibited. That is, it became easier for the negative electrode lead 52 to be welded to the cover part 12 by means of a resistance welding method, which prevented occurrence of poor welding of the negative electrode lead 52. However, occurrence of creeping up of the electrolytic solution along the negative electrode lead 52 caused the electrolytic solution to reach the sidewall part M3 easily, and as a result, it became difficult for the cover part 12 to be welded to the container part 11, which caused poor welding of the outer package can 10 to occur. In this case, the tip part 52B was in contact with the sidewall part M3, which resulted in constant occurrence of poor welding of the outer package can 10.

In contrast, in a case where the negative electrode lead 52 was so coupled to the negative electrode 42 as to protrude upward from the battery device 40 and where the tip part 52B was bent in the direction approaching the winding center space 40K, i.e., in Example 1, the trade-off relationships described above were overcome. That is, the electrolytic solution was prevented from reaching the sidewall part M3 easily even if creeping up of the electrolytic solution along the negative electrode lead 52 occurred, and as a result, it became easier for the cover part 12 to be welded to the container part 11, which prevented poor welding of the outer package can 10 from occurring as a result of using a laser welding method. Moreover, it became easier for the negative electrode lead 52 to be welded to the cover part 12 by means of a resistance welding method, which prevented occurrence of poor welding of the negative electrode lead 52. In this case, it was unnecessary to place a welding electrode inside the winding center space 40K, which prevented occurrence of poor welding of the negative electrode lead 52, regardless of the inner diameter N of the winding center space 40K.

The results presented in Table 1 indicate that, in a case where the positive electrode lead 51 was so coupled to the positive electrode 41 as to protrude from the battery device 40 toward the cover part 12 and was coupled to the external terminal 20, where the negative electrode lead 52 was so coupled to the negative electrode 42 as to protrude from the battery device 40 toward the cover part 12 and was coupled to the cover part 12, and where the tip part 52B of the negative electrode lead 52 was bent in the direction approaching the winding center space 40K and was coupled to the cover part 12, no poor welding of the negative electrode lead 52 occurred, and no poor welding of the outer package can 10 occurred. Accordingly, the negative electrode lead 52 was stably coupled to the cover part 12, and the cover part 12 was stably joined to the container part 11, which allowed the secondary battery to achieve superior manufacturing stability.

Although the present technology has been described herein according to one or embodiments including Examples, the configuration of the present technology is not limited thereto, and is therefore modifiable in a variety of ways.

For example, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing it intended advantages. It is therefore intended that such changes and modifications be covered by the appended claims.

1. A secondary battery comprising:
an outer package member having a flat and columnar shape and including a first bottom part and a second bottom part opposed to each other;
an electrode terminal provided on the first bottom part and insulated from the first bottom part;
a battery device contained inside the outer package member and including a first electrode and a second electrode, the first electrode and the second electrode being opposed to each other and being wound;
a first wiring line that is so coupled to the first electrode as to protrude from the battery device toward the first bottom part and is coupled to the electrode terminal; and
a second wiring line that is so coupled to the second electrode as to protrude from the battery device toward the first bottom part and is coupled to the first bottom part, wherein
the battery device has a winding center space at a center around which the first electrode and the second electrode are each wound, and
the second wiring line includes a tip part that is bent in a direction approaching the winding center space and is coupled to the first bottom part.

2. The secondary battery according to claim 1, wherein
the outer package member further includes a sidewall part provided between the first bottom part and the second bottom part, and
the second wiring line is separated from the sidewall part.

3. The secondary battery according to claim 2, wherein
the battery device further includes a separator provided between the first electrode and the second electrode,
the first electrode, the second electrode, and the separator are wound in such a manner that the separator is disposed in an outermost wind, and
the second wiring line is separated from the sidewall part, the separator disposed in the outermost wind in the battery device being provided between the second wiring line and the sidewall part.

4. The secondary battery according to claim 1, wherein the second wiring line is folded back once or more between the battery device and the first bottom part.

5. The secondary battery according to claim 4, wherein the second wiring line has a crease at a location where the second wiring line is folded back.

6. The secondary battery according to claim 1, wherein the tip part is separated from the first wiring line, and is so disposed as not to overlap with the first wiring line.

7. The secondary battery according to claim 1, wherein a position where the first wiring line is coupled to the first electrode and a position where the second wiring line is coupled to the second electrode are opposed to each other with the winding center space provided therebetween.

8. The secondary battery according to claim 1, wherein the first wiring line is coupled to the first electrode in a region on a front side relative to the winding center space, and is extended from the region on the front side relative to the winding center space to a region on a back side relative to the winding center space.

9. The secondary battery according to claim 1, wherein the first wiring line is folded back once or more between the battery device and the electrode terminal.

10. The secondary battery according to claim 9, wherein the first wiring line has a crease at a location where the first wiring line is folded back.

11. The secondary battery according to claim 1, wherein
the outer package member further includes a sidewall part lying between the first bottom part and the second bottom part, and
a length of the first wiring line between the battery device and the electrode terminal satisfies a relationship represented by Expression (1) below,
L1≥(L2+L3) (1)
where
L1 is the length of the first wiring line between the battery device and the electrode terminal,
L2 is a distance from a position where the first wiring line is coupled to the first electrode, to the sidewall part located on a side opposite, across the winding center space, to the position where the first wiring line is coupled to the first electrode, and
L3 is a distance from the sidewall part located on the side opposite, across the winding center space, to the position where the first wiring line is coupled to the first electrode, to a position where the first wiring line is coupled to the electrode terminal.

12. The secondary battery according to claim 1, wherein
the secondary battery comprises a plurality of the first wiring lines, and
the secondary battery further comprises a first electric coupling member that couples the plurality of first wiring lines to each other.

13. The secondary battery according to claim 1, wherein
the secondary battery comprises a plurality of the second wiring lines, and
the secondary battery further comprises a second electric coupling member that couples the plurality of second wiring lines to each other.

14. The secondary battery according to claim 1, wherein
the first bottom part includes a recessed part resulting from the first bottom part being bent to protrude in part toward an inside of the outer package member, and
at least a portion of the electrode terminal is disposed inside the recessed part.

15. The secondary battery according to claim 1, wherein
the outer package member further includes a sidewall part lying between the first bottom part and the second bottom part,
the outer package member includes
a cover part corresponding to the first bottom part, and
a container part containing the battery device inside, the container part corresponding to the second bottom part and the sidewall part and having an opening, and
the cover part is welded to the container part at the opening.

16. The secondary battery according to claim 1, wherein the secondary battery comprises a lithium-ion secondary battery.
